(19) United States
(12) Patent Application Publication
(10) Pub. No.: US 2010/0056669 A1
(43) Pub. Date: Mar. 4, 2010

(54) RUBBERIZED ASPHALT PELLETS

(76) Inventor: William R. Bailey, Las Vegas, NV (US)

Correspondence Address: Workman Nydegger;1000 Eagle Gate Tower, 60 East South Temple, Salt Lake City, UT, 84111, US

(21) Appl. No.: 12/548,102

(22) Filed: Aug. 26, 2009

Related U.S. Application Data
(60) Provisional application No. 61/093,193, filed on Aug. 29, 2008.

(51) Int. Cl. C09D 195/00; B05D 5/00

(52) U.S. Cl. 523/201; 523/207; 427/180

(57) ABSTRACT

A storage-stable rubberized asphalt paving pellet can include fines in the core. The core can be an asphalt-based binder at about 70% to about 95% by weight of the core. The asphalt-based binder can include: ground tire rubber from about 15% to about 30% by weight of the asphalt-based binder, and pavement grade asphalt from about 85% to about 70% by weight of the asphalt based binder. The core can include fines at about 30% to about 1% by weight of the core. The shell coating the core can provide the pellet with a maximum dimension of about 1/16 inch to about 2 inches. The shell can include a water-resistant polymer or wax, or a coating of fines. In one aspect, the fines are lime fines or ground asphalt pavement fines. Optionally, the fines can be mineral or rock fines as described herein.

### CROSS-REFERENCE TO RELATED APPLICATIONS

This application claims the benefit of U.S. provisional patent application having Ser. No. 61/093,193, filed on Aug. 29, 2008, entitled “RUBBERIZED ASPHALT PELLETS,” with William R. Bailey as the inventor, which application is incorporated herein in their entirety by specific reference.

### BACKGROUND OF THE INVENTION

Asphalt pavements are well-known and have been used for many years. Typically, an asphalt pavement includes an aggregate and asphalt cement mixed together in what is commonly referred to as hot mix asphalt (HMA). The asphalt cement is a hydrocarbon-rich substance such as, or prepared from, bitumen, and is used to bind the aggregate into a pavement. The type and amount of aggregate can vary, and it provides structural reinforcement and durability to the HMA. While the asphalt cement functions as a continuous phase that binds the aggregate materials together, it is well known that various additives such as carbon black, fibers or lime can be used to improve the durability and longevity of asphalt pavements.

Currently, the preparation of asphalt pavement is tedious, expensive, and requires a significant amount of energy to heat and maintain a temperature of liquid asphalt. HMA is produced by heating the asphalt binder to decrease its viscosity, and drying the aggregate to remove moisture from it prior to mixing. When asphalt is in a container that is not kept at a heated temperature, the asphalt hardens and requires additional energy to heat into a mixable consistency. Mixing is generally performed with the aggregate at about 300° F. (roughly 150° C.) for virgin asphalt and 330° F. (166° C.) for polymer modified asphalt, and the asphalt cement at 200° F. (95° C.). Paving and compaction must be performed while the asphalt is sufficiently hot.

Asphalt pavement usually includes finely divided substances as aggregates or filler. The aggregates or filler can be used in any type of asphalt composition, and are selected depending on the grading, strength, toughness, and stability for the asphalt pavement. Aggregates include a variety of materials in a variety of shapes and sizes. Examples of aggregates include lime, quicklime, sand, gravel, crushed stone, slag, recycled concrete, and the like. One example is mineral filler, which is typically very fine, inert materials that are added to asphalt, such as hot mix asphalt, to improve the density and strength of the mixture. Examples of mineral filers include rock dust, slag dust, hydrated lime, hydraulic cement, fly ash, fibers, and the like.

### SUMMARY

In one embodiment, the present invention can include a storage-stable rubberized asphalt paving pellet. The rubberized asphalt paving pellet can include a core and a shell. The core can include ground tire rubber from about 15% to about 30% by weight of the core, and pavement grade asphalt from about 85% to about 70% by weight of the core. The shell can coat the core such that the pellet has a maximum dimension of about 1/16 inch to about 2 inches. The composition of the shell can be a water-resistant polymer or wax, or it can be a coating of fines.

In one embodiment, the rubberized pellet can be characterized by one or more of the following: the ground tire rubber at about 15% to about 25% by weight of the total pellet; the pavement grade asphalt at about 50% to about 60% by weight of the total pellet; the core having less than about 10% by weight being sulfur; the fines are lime fines at less than about 25% by weight of the total pellet; or the coating is sulfur (e.g., elemental sulfur), polymer, fines, or wax.

In one embodiment, a storage-stable rubberized asphalt paving pellet can include fines in the core. Such a pellet can include a core with an asphalt-based binder at about 70% to about 95% by weight of the core, the asphalt-based binder comprising: ground tire rubber from about 15% to about 30% by weight of the asphalt-based binder; and pavement grade asphalt from about 85% to about 70% by weight of the asphalt based binder. The core can include fines at about 45% to about 1% by weight of the core. The shell coating the core can provide the pellet with a maximum dimension of about 1/16 inch to about 2 inches. The shell can include a water-resistant polymer or wax, or a coating of fines. In one aspect, the fines are lime fines or ground asphalt pavement fines. Optionally, the fines can be mineral or rock fines as described herein.

In one embodiment, the rubberized pellet is characterized by one or more of the following: the ground tire rubber at about 15% to about 25% by weight of the total pellet; the pavement grade asphalt at about 50% to about 60% by weight of the total pellet; the core having less than about 10% by weight being sulfur; the fines are lime fines at less than about 25% by weight of the total pellet; or the coating is wax.

In one embodiment, the pellet can be characterized by one or more of the following: the ground tire rubber from about 20% to about 26% by weight of the asphalt-based binder; the pavement grade asphalt from about 74% to about 80% by weight of the asphalt based binder; or the fines are lime fines at less than about 45% by weight of the total pellet.

Additionally, the pellet can further include one or more of the following: rock and/or mineral fines; an additional bituminous binder; a non-bituminous binder; a structural additive; a colorant; a salt; or a rheology-modifier. The non-bituminous binder can be selected from the group of hydrophobic binders, cellulosic binders, hydrophilic binders, organic binders, natural polymer binders, lignin and/or lignosulfonate or acid thereof, polysaccharide or modified polysaccharide binder, or combinations thereof. Other components described herein can also be included.

In one embodiment, the present invention can include a method of manufacturing a rubberized asphalt pellet as described herein. The method can include: obtaining the ground tire rubber; obtaining the pavement grade asphalt; reacting the ground tire rubber and pavement grade asphalt for at least 45 or 60 minutes to form a reaction mixture; combining the reaction mixture with fines to form the core; and coating the core with a shell to form the pellet. Typically, the reacting is conducted at about 350 to about 380 degrees F., however, the temperature range can be +/−10 degrees or even +/−20 degrees.

A method of manufacture can include one or more of the following: reacting the ground tire rubber at about 15% to about 25% by weight of the total pellet with the pavement grade asphalt at about 50% to about 60% by weight of the total pellet; reacting the ground tire rubber from about 20% to about 26% by weight of the asphalt-based binder with the pavement grade asphalt from about 74% to about 80% by weight of the asphalt based binder; inhibiting the core from having more than about 10% by weight being sulfur; inhibiting the amount of fines to be more than about 45% by weight of the total pellet; spraying the water-resistant coating onto the pellet; or applying the fines as a coating onto the pellet.

A method of manufacture can include one or more of the following: combining rock and/or mineral fines with the reaction mixture with fines to form the core; combining an additional bituminous binder with the reaction mixture with fines to form the core; combining a non-bituminous binder with the reaction mixture with fines to form the core; combining a structural additive the reaction mixture with fines to form the core; combining a colorant with the pellet; combining a salt with the reaction mixture with fines to form the core; or combining a rheology-modifier with the reaction mixture with fines to form the core. The method can include combining the asphalt with a non-bituminous binder selected from the group of hydrophobic binders, cellulosic binders, hydrophilic binders, organic binders, natural polymer binders, lignin and/or lignosulfonate or acid thereof, polysaccharide or modified polysaccharide binder, or combinations thereof. Optionally, the fines consist essentially of calcium hydroxide and/or calcium oxide.

In one embodiment, the present invention can include a method of preparing paving asphalt composition. Such a method can include providing the rubberized asphalt pellet as described herein; heating the asphalt pellets into a liquefied asphalt composition; and combining the liquefied asphalt composition with aggregate. The paving asphalt composition can include the aggregate in an amount at least about 90% by weight of the paving asphalt composition. In one aspect, the heating is performed at a temperature lower than 325 degrees F. For example, the heating can be performed at a temperature range from about 270 degrees F. to about 290 degrees F., or about 280 degrees F.

Additionally, the method can include adding additional pavement grade asphalt to the liquefied asphalt composition, wherein the additional pavement grade asphalt is an amount from about 1% to about 5% of the amount of the asphalt pellet.

In one embodiment, the present invention can include an asphalt pellet product that includes a meltable bag capable of melting at 200 degress F. filled with rubberized asphalt pellets. The bag can include from about 25 to about 100 pounds, however, heavy duty bags may be capable of carrying larger quantities, such as, for example up to 200 pounds. Usually, the bags will carry between about 50 and 75 pounds or around 60 pounds. The metlable bag can be any fabric, paper, and/or plastic bag as is commonly used to transport pellets. On example would be a paper-based bag lined with a polyolefin liner.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a schematic representation of a rubberized asphalt pellet 1 having a core 3 and shell 2 in accordance with the present invention.

FIG. 1B is a schematic representation of a bag 4 containing a plurality of pellets 1.

FIG. 1C is a schematic representation that illustrates an embodiment of a pelleting system and process for preparing paving pellets.

FIG. 2 is a schematic representation that illustrates an embodiment of a pelleting system and process for preparing paving pellets.

FIG. 3 is a schematic representation that illustrates an embodiment of a pelleting system and process for preparing pellets.

FIG. 4 is a schematic representation that illustrates an embodiment of a system and process for conditioning asphalt during the manufacture of hot mix asphalt.

FIG. 5 is a schematic representation that illustrates embodiments of asphalt paving with pellets.

FIG. 6 is a schematic representation that illustrates embodiments of asphalt paving with pellets.

### DETAILED DESCRIPTION OF THE INVENTION

Generally, embodiments of the present invention are directed to asphalt pellets, pellet production, and the use of asphalt pellets in asphalt applications, such as preparing hot mix asphalt compositions and in asphalt paving. The terminology employed herein is used for the purpose of describing particular embodiments only and is not intended to be limiting.

### I. Definitions

As used herein, the term “lime” is meant to refer to calcium hydroxide (Ca(OH)₂) and/or calcium oxide (CaO); however, it is not meant to refer to limestone. As such, any reference to lime is meant to include compositions having calcium hydroxide or calcium oxide as well as compositions predominately comprised of calcium hydroxide or calcium oxide, whether it is dolomitic or high-calcium, and meant to specifically exclude untreated-limestone.

Accordingly, lime can be high calcium hydrated lime. High calcium quicklime produces a hydrated lime containing generally 72 to 74 percent calcium oxide and 23 to 24 percent chemically combined water. Also, the lime can be dolomitic hydrated lime (normal), whereby under atmospheric hydrating conditions only the calcium oxide fraction of dolomitic quicklime hydrates, producing a hydrated lime of the following chemical composition: 46 to 48 percent calcium oxide, 33 to 34 percent magnesium oxide, and 15 to 17 percent chemically combined water. Additionally, the lime can be dolomitic hydrated lime (pressure), whereby this lime is produced from dolomitic quicklime under pressure, which results in hydrating all of the magnesium oxide as well as all of the calcium oxide, producing the following chemical composition: 40 to 42 percent calcium oxide, 29 to 30 percent magnesium oxide, and 25 to 27 percent chemically combined water. Further, the lime can be high calcium quicklime, whereby the lime is derived from limestone containing 0 to 5 percent magnesium carbonate. Furthermore, the lime can be dolomitic quicklime, whereby the lime is derived from limestone containing 35 to 46 percent magnesium carbonate.

As used herein, the term “hydrated lime” is meant to refer to calcium hydroxide (Ca(OH)₂). Also, hydrated lime can be used to describe compositions that are predominately hydrated lime, but also include some limestone, quicklime, or other materials.

As used herein, the term “quicklime” is meant to refer to calcium oxide (CaO). Also, quicklime can be used to describe compositions that are predominately quicklime, but also include some limestone, hydrated lime, or other materials.

As used herein, the term “limestone” is meant to refer to mineral calcite, which is also referred to as calcium carbonate (CaCO₃). Limestone is not meant to refer to limes, such as quicklime or hydrated lime. Limestone includes calcium carbonate and other materials found naturally and well known to be included in limestone.

As used herein, the term “fines” is meant to refer to the small particulate nature of the powders of less than 8 mesh used in hot asphalt mix production. As such, the lime fines, mineral fines, or other fines are small, finely divided, and light weight particulates that are easily airborne when handled or exposed to minimal air currents. For example, powders can be comprised of a majority of lime fines less than 5 microns.

As used herein, the term “storage-stable” is meant to refer to a physical characteristic that inhibits or prevents a pellet from degrading or combining with adjacent pellets under ambient conditions. That is, when under normal ambient conditions at a normal humidity, the pellets are form-stable. As such, when a plurality of storage-stable pellets are piled in storage, the individual pellets retain their distinct structural integrity without forming an agglomeration of pellets.

As used herein, the terms “aggregate” or “asphalt aggregate,” is meant to refer to a broad category of fine, medium, and/or coarse particulate materials used in the preparation of asphalt. Examples of aggregates include sand, gravel, crushed stone, slag, recycled concrete, mineral filler, and the like. Aggregates are a component of asphalt pavement; the aggregate serves as reinforcement to add strength to the overall asphalt pavement or other asphalt material.

As used herein, the term “mineral filler” or “mineral” is meant to refer to fine or very fine mineral matter that can be inert or beneficial to asphalt products and asphalt pavement. Mineral fillers are a type of aggregate that can be used to improve the density and/or strength of an asphalt composition, such as asphalt pavement. Examples of mineral filers include rock dust, slag dust, hydrated lime, hydraulic cement, fly ash, loess, and the like.

Concentrations, amounts, temperatures, dissolution rates, and other numerical data may be presented in a range format. It is to be understood that such a range format is used merely for convenience and brevity and should be interpreted flexibly to include not only the numerical values explicitly recited as the limits of the ranges, but also to include all the individual numerical values or sub-ranges encompassed within that range as if each numerical value and sub-range is explicitly recited. For example, bitumen can be present in the pellets as an asphalt-compatible binder at various compositions within a range of from about 5% to about 99% by dry weight. This recited range should be interpreted to include not only the explicitly recited limits of about 5% and about 99%, but also to include such individual compositional percentages such as 25%, 32%, 40%, 53%, 70%, 80%, 90% and 98% as well as sub-ranges between these individual percentages. This interpretation should apply regardless of the breadth of the range or the characteristic being described, and should apply to ranges having both upper and lower numerical values as well as open-ended ranges reciting only one numerical value.

### II. Asphalt Pellets

In accordance with an embodiment of the present invention, the asphalt pellets are prepared in a manner that binds fines with asphalt and/or an asphalt-compatible binder. Embodiments of the methods for manufacturing asphalt pellets according to the present invention include combining an asphalt material with a ground rubber material and optionally other particulates so that the ground rubber combines with the asphalt to form a pellet. The asphalt can be any grade of asphalt that is useful for asphalt pavement, and can include bitumen, tall oil pitch, asphalt, asphalt cement. The rubber can be new rubber or recycled tire rubber that is ground to the appropriate size for pelleting.

Examples of rubberized asphalt pellets having a core and shell can include fines (e.g., lime fines) at an amount about 30-40% by weight of the total pellet or core, asphalt at an amount about 50-55% by weight of the total pellet or core, and rubber (e.g., from ground tire rubber or other source) at an amount about 15-20% by weight of the total pellet or core. These values can all, independently, be varied by +/−5%, +/−10%, or +/−15% depending on the configuration. Also, the fines can be reduced to less than 20%, less than 10%, and may be omitted in some instances

In one embodiment, the asphalt pellet can be prepared by mixing fines with an asphalt binder and a ground rubber material. The fines can be any fines described herein; however, lime fines can be especially beneficial. The asphalt binder can be bitumen, tall oil pitch, asphalt, asphalt cement, or the like. Also, the asphalt binder can be pre-rubberized asphalt. The ground rubber material can be ground asphalt rubber, synthetic or natural rubber (e.g. emulsified tire rubber, crumb rubber, ground tire rubber, etc.). Additionally, other binders such as lignosulfonate or others described herein can be used to bind the asphalt into a pellet with the ground rubber material. The mixed materials can then be formed into pellets in the shape of pastilles, slates, chips, briquettes, or other small forms. The asphalt paving pellets can be coated in a coating apparatus with a polymer or wax shell that is compatible with the asphalt oil or bitumen. Also, fines, such as lime fines can be coated onto the outside of an asphalt pellet so that the handling properties are improved and less messy.

The resulting asphalt paving pellets (e.g., asphalt pellets) are suitable for storage and transportation at a wide range of ambient temperatures because of their rigid and non-flow properties. The asphalt pellets can be stored at the production site or at a remote site and can be transported and stored in piles or within containers such as sacks, tanks, silos, and barrels. Unlike other asphalt binder products, the asphalt paving pellets of the present invention can be stored in piles, bags, or in containers without agglomerating together into a sticky mound because the individual asphalt pellets are configured to remain substantially stable and unitary. However, some degree of sticking together is allowable so long as the pellets retain some fluidity in being capable of being poured from a bag, shoveled, and handled as pellets and as described herein.

Previously, some asphalt products in the form of larger blocks, chunks, or prills have been attempted without success because of the sticky nature and malleability of the asphalt material. These products were formed by prilling and resulted in sticky and malleable products that agglomerated and melded together during storage. Such products are not suitable for the purposes and uses described herein. The present invention overcomes the problems associated with sticky, malleable, and agglomerating asphalt products by including ground rubber materials, and optionally fines that facilitate the binding of the asphalt into an asphalt pellet that is suitable for the purposes and uses described herein. Additionally, the use of an optional wax or wax-like coating can increase the individuality of each pellet to inhibit or prevent agglomeration or other association with adjacent pellets during storage. Fines can also be used to coat onto asphalt pellets that have some stickiness, and the fines then provide a dry coating layer.

The ability to store the asphalt pellets without degradation or agglomeration permits the accumulation of large quantities of pellets and shipment in large quantities to remote locations and the stockpiling thereof. It also allows for such storage and shipping to take place in individual bags of asphalt pellets, such as bags from 25 to 100 pounds. Often the bags of asphalt pellets are about 50 to about 60 pounds for easy of handling.

The properties of the various embodiments of pellets according to the present invention are such that the pellets can effectively be shipped over long distances, such as by transoceanic and/or transcontinental shipments, by any one of a variety of conventional means, such as rail cars, trucks, ships, and airplanes. Properties that facilitate the storage and shipment of the inventive pellets in large quantities include the rigid, non-sticky, non-aggregating, and non-flow properties that enable handling without the concerns associated with fines, such as lime fines, or particulates becoming airborne.

In one embodiment, the individual asphalt pellets are storage-stable so as to not agglomerate with adjacent pellets into a sticky mass of asphalt. For example, an individual asphalt pellet does not substantially degrade or agglomerate with adjacent pellets for a duration longer than about 30 days, more preferably longer than about 60 days, and most preferably longer than about 90 days. Moreover, some asphalt pellet configurations can be form-stable for longer than about 6 months or longer than about 12 months. As such, when asphalt pellets are stored at normal or natural ambient conditions and humidity, the individual pellets retain their form. While some agglomeration or sticking together is allowable for the asphalt pellets, such agglomeration or sticking together can be minimal so that the overall bulk of the pellets retain their individuality and usability as pellets. This can include the pellets being flowable when the storage vessel is vibrated (e.g., with an air hammer) to allow them to be augered or pored from a container and having overall fluidic properties for a bulk supply of pellets. When a bag of asphalt pellets is exposed to unfavorable conditions that cause some agglomeration, the bag can be impacted, such as by dropping, to break apart into the individual asphalt pellets.

Embodiments of applications suitable for using the asphalt pellets according to the present invention include their use in hot mix plants where the asphalt pavement end product is produced for transportation and delivery to the paving site. Other applications of pellets according to the present invention include use in roadside paving operations, either alone or in combination with other paving materials. For example, the asphalt can be used for new or resurfacing asphalt pavement alone or in combination with other aggregates, minerals, additives, asphalt, or other asphalt paving materials. The pellet compositions can be sufficient for direct use as an asphalt pavement, or can be cut with additional hot asphalt.

Some embodiments of asphalt pellets according to the present invention, such as those prepared with lime, are configured so as to protect asphalt pavement against water-induced detrimental effects, thus preventing or reducing undesirable effects that sometimes occur due to long-term exposure to the storage vessel subject to precipitation such as rain, snow, and/or ice. Also, the pellets having lime can prevent or inhibit oxidative age hardening of the asphalt pavement. Some embodiments of pellets according to the present invention are provided with components, modifiers, and/or colorants that provide the dark or black colored asphalt pavement that is familiar and preferred.

In order to achieve the foregoing properties, it can be preferred that the asphalt pellets have a size that prevents them from becoming easily airborne due to wind currents or handling. It has been found that when the pellets are at least larger than 14 mesh so as to not pass therethrough, ease of use and handling greatly increases. For example, the pellets can have a dimension greater than about 1.5 mm (about 0.05 inch) to inhibit or prevent being passed through about 14 mesh, more preferably to prevent being passed through about 40 mesh, and most preferably to prevent being passed through about 80 mesh. The lime pellets can be configured to be any size that is reasonable for the application and the size of individual pellets within a batch can vary across a broad range. Also, the pellets can be configured to be from about 1/16 inch to about 2 inches, more preferably from about ⅛ inch to about 1.5 inches, even more preferably from about ¼ inch to about 1 inch, and most preferable from about ¼ inch to about ¾ inch. Examples include pellets that are the size of a bb (0.171 to 0.173 inches or 4.34 mm to 4.39 mm in diameter) that can be used in a bb gun, the size of a pea, or the size of sphere with a nickel-sized diameter.

Additionally, the shape of the pellets can be varied and still retain the foregoing properties. Examples of suitable pellet shapes include those that are substantially similar to spheroids, prills, pastilles, chips, cubes, bricks, tablets, slates, chunks, irregularly-shaped pellets, and the like.

In one embodiment, the pellets can be comprised of a shell and core. As such, a binder shell is formed around the asphalt core. The core can be substantially an asphalt pellet as described herein, and the shell can be a coating (e.g., polyvinylalcohol, polyvinylacetate, bitumen, waxes, sasol waxes, sasobit, petroleum waxes, high temperature waxes, and the like) that increased the durability and/or storability of the pellets. Alternatively, the shell can be a fines shell that is prepared by passing the asphalt pellet through fines so that the fines coat and stick to the asphalt pellet to form a dry coating. Additionally, the shell and core pellets can be configured to have one or more cores of asphalt compositions and/or one or more shells. This can include a single core with multiple shells or multiple cores with a single shell.

### III. Pellet Compositions

A. Asphalt

Generally, an embodiment of an asphalt pellet in accordance with the present invention includes an asphalt composition that acts as a binder and binds with the rubber particulates to form the pellet. The asphalt is paving grade asphalt so that the asphalt pellets that are rubberized can be directly used as a source for preparing asphalt paving compositions that also include aggregate. Accordingly, the binder compositions that form the core of the pellets include the paving grade asphalt and optionally other binding components described herein.

The asphalt binder can be any asphalt composition, such as asphalt cement. Asphalt is a stick, black and highly viscous liquid or semi-solid that is present in most crude petroleums and in some natural deposits sometimes termed asphaltum. Also, asphalt or asphalt cement can be a refined residue from distillation of select crude oils. As such, examples of such asphalt cements are commonly abbreviated with the terms AC-xx. The notation “xx” in the description of AC asphalt represents a numeral related to the asphalt viscosity. Asphalts such as AC-20 and AC-10 are the preferred forms to be used as binders. Other forms of asphalt that are contemplated as constituents in binder formulations include AC-1.75, AC-2.5, AC-5, AC-30, AC-40, AC-80, and AC-120 asphalts. Also, the super pave grading system “PG-xx-xx” (e.g., PG-76-22) can be used to identify asphalt oils, wherein the “xx” notations designate temperatures in Celsius for the performance grade.

Additionally, the asphalt pellet can also include an asphalt-compatible binder. By being “asphalt-compatible,” it is meant to include any binder that can bind particulates and/or fines into an asphalt-based pellet for use in asphalt paving, asphalt conditioning, or asphalt pavement repair or resurfacing without the binder unfavorably altering the characteristics of the asphalt. As such, the asphalt-compatible binder does not impart any or significant detrimental characteristics to the asphalt pavement so as to undermine the use of such a pellet. A wide range of asphalt-compatible binders can be employed which include hydrophobic binders (e.g., bitumen-based, oil-based, rubber-based, and polymer-based binders), hydrophobic/hydrophilic binders (e.g., binders having a hydrophobic portion and a hydrophilic portion such as asphalt emulsions), and hydrophilic binders (e.g., lignin-based binders).

For example, the pellet or core of the pellet can include an asphalt-based binder, such as a rubberized asphalt binder, at more than or about 70% by weight of the total pellet, preferably more than or about 80% by weight of the total pellet, more than or about 90% by weight of the total pellet, more than or about 99% of the total pellet, more than or about 99.25% of the total pellet, or more than or about 99.5% of the total pellet. In yet another example, the pellet can include an asphalt-based binder, such as a rubberized asphalt binder, from about 50% to about 70% by weight of the total pellet, preferably about 70% to about 80% by weight of the total pellet, more preferably about 80% to about 90% by weight of the total pellet, even more preferably about 90% to about 99% of the total pellet, still more preferably about 99% to about 99.25% of the total pellet, and most preferably about 99.25% to about 99.5% of the total pellet. The balance of the pellet or core of the pellet can be fines, and the coating or shell can be fines or a water-resistant coating such as a polymer or wax.

In one embodiment, the asphalt or asphalt-compatible binder is comprised of bitumen. Bitumen is a generic term referring to a flammable mixture of various hydrocarbon materials derived naturally or by distillation from petroleum, shale oil or tar sands. Usually, bitumen has a dark brown or black color, and can be present in forms that range from sticky and/or viscous oils to brittle solids such as asphalt, tars, and natural mineral waxes. Examples of substances containing bitumen include bituminous coal, tar, pitch, or Engen Bitumen 110-2™ (Engen Petroleum Limited; South Africa). When used, the pellets can include bitumen at general binder concentrations, or at a concentration ranging from about 30% to about 95% of the total binder, more preferably from about 35% to about 89% or 90% of the total binder, and most preferably about 45% to about 85% by total weight of the total binder. A specific example includes bitumen at 75% by total weight of the binder. Asphalt and bitumen are sometimes terms that are used interchangeably. When the bitumen is asphalt-grade, it is considered to be asphalt. Otherwise, it can be used as an asphalt-compatible binder.

While bitumens can include elemental sulfur, it can be preferred that the binder does not include any additional sulfur such as elemental or unprocessed sulfur. For example, it can be preferred that the binder includes sulfur in an amount less than about 30% by weight of total binder, more preferably less than about 20% by weight of total binder, less than about 10%, and most preferably with no sulfur added to the binder.

Additionally, other hydrocarbon-based materials can be used an asphalt-compatible binder to bind fines. Examples of some hydrocarbon-based materials include heavy crude oil, fuel oil, tall oil pitch, and the like. Also, these materials can be added as constituents in asphalt cement formulations or bitumen compositions. For example, when tall oil pitch or asphalt pitch is used it can bind the fines at about 0.5% to about 20% by weight of the pellet or at any amount or percentage of binder as described herein.

B. Rubber

Generally, the rubberized asphalt pellets, which are also generically referred to as asphalt pellets herein, include rubber components. The rubber can be heated and reacted with the asphalt to absorb the rubber prior to or during the formation of the pellet. The rubberized asphalt pellets can also include rubber particles. Examples of rubbers can include natural and synthetic rubbers. Also, the rubber can be obtained from tire rubber in the form of crumb rubber or ground tire rubber. Such tire rubber can be ground up into particles and emulsified with the asphalt. Additionally, the tire rubber can be pre-reacted into a sticky composition, such as with an asphalt-based composition that is suitable for agglomerating fines into a pellet. Similarly latex rubber can also be used in both the natural and synthetic forms.

The process of preparing the rubberized asphalt pellets can include grinding used rubber, such as used tire rubber, into particles for use in manufacturing the asphalt pellets. The rubberized pellets of the present invention include emulsified rubber and/or rubber particles that agglomerate with the asphalt to form a pellet. The rubber is ground to a particulate size that can range from the size of fines to sizes smaller than the pellets. It is preferable to form the pellets from a plurality of rubber particles. This includes at least 2 or more rubber particles, more preferably about 2 to 10 particles, more preferably about 5 to about 50 particles, and most preferably about 10 to 100 or more particles of rubber.

The tire rubber that is used to make the asphalt/rubber binder can be provided in various sizes. However, it can be beneficial for the rubber to be ground to less than or about 8 mesh, more preferably less than or about 14 mesh, and most preferably less than or about 20 mesh.

C. Limestone

Limestone is well known to be used as a source or starting product for preparing quicklime and hydrated lime. As such, the limestone can be provided as limestone fines that can be heated to at least 825° C. in order to produce powdered quicklime fines. Alternatively, the limestone can be provided as a limestone rock which is crushed into the limestone fines suitable for producing powdered quicklime fines. The limestone rock can be provided in any size that is suitable for being crushed or pulverized into limestone fines. The size of limestone suitable for being cooked into quicklime can be characterized as being less than about ⅛ inch, more preferably less than 1/16 inch, even more preferably less than about 1/32 inch, and most preferably less than about 1/64 inch. Also, the limestone suitable for being cooked into quicklime can be characterized as passing through about 25 mesh, more preferably about 50 mesh, even more preferably about 75 mesh, and most preferably about 100 mesh. Cooking limestone can cause the limestone to disintegrate into fines.

Limestone fines can also be used for preparing the asphalt pellets as described herein. As such, the limestone can be pulverized into suitable fines that can be processed into an asphalt pellet as described herein.

The limestone in powdered or rock form may include other substances. Since limestone is a natural product, the composition of limestone can vary greatly depending on geographic location and geologic conditions. Also, limestone is mined and can include a number of additional substances, such as other rocks, sands, soil, and natural substances. While any additional substance can be removed from the limestone before being cooked or pelleted with asphalt, these additional substances may be included with the limestone if it is determined that their presence does not interfere with the production of an asphalt pellet for use in asphalt conditioning applications.

Limestone is characterized as being comprised of calcium carbonate (CaCO₃). As such, the present invention can be practiced with calcium carbonate, and it should be understood that references to limestone are intended to include pure calcium carbonate as well as compositions of calcium carbonate and additional substances that do not interfere with the production of quicklime, hydrated lime, or the lime pellets described herein. Accordingly, the calcium carbonate can be provided in chunks or rocks that can be crushed into calcium carbonate fines.

D. Lime

In one embodiment, the pellets prepared in accordance with the present invention can include calcium hydroxide (Ca(OH)₂). More particularly, the calcium hydroxide is presented as finely divided particulates that are held together in the pellet with a suitable binder and/or asphalt. Calcium hydroxide is also known as calcium dihydroxide, calcium hydrate, lime hydrate, or hydrated lime. For example, the lime can be hydrated forms of quicklimes of high calcium dolomitic, hydrated forms of lime having the primary constituents CaO CaO.MgO or primary constituents Ca(OH)2Ca(OH)2.MgOCa(OH)2.Mg(OH)₂, and the like. The calcium hydroxide fines can be produced by reacting water with calcium oxide (CaO) in an atmospheric hydrator. Usually, calcium hydroxide is a white finely divided powder having an average diameter of less than about 0.15 mm so as to pass through about 100 mesh. Additionally, calcium hydroxide fines can include traces of calcium oxide, magnesium oxide, calcium sulfate, ferric oxide, and silica. Moreover, in certain instances it can be preferred that the only lime component in the pellet is calcium hydroxide so as to be substantially devoid of calcium oxide and/or limestone.

In one embodiment, the pellets prepared in accordance with the present invention can include calcium oxide (CaO). More particularly, the calcium oxide is presented as finely divided particulates that are held together in the pellet with a suitable binder and/or asphalt. Calcium oxide is also known as calcium monoxide, quicklime, or burnt lime, and may have primary constituents CaO or CaO.MgO. Usually, calcium oxide is a white or slightly yellowish finely divided powder. Additionally, calcium oxide fines can include traces or small amounts of magnesium oxide, ferric oxide, and silicon oxide. Calcium oxide is a basic anhydride, and reacts with water to form calcium hydroxide. Moreover, in certain instances it can be preferred that the only lime component in the pellet is calcium oxide so as to be substantially devoid of calcium hydroxide and/or limestone. The pellets can include calcium oxide in a variety of concentrations including those similar to calcium hydroxide or other fines.

Additionally, in some embodiments and/or applications it can be preferred to have pellets that are comprised of both calcium hydroxide and calcium oxide. This enables the pellets to provide the benefits of both chemicals to the asphalt pavement and/or soil. More particularly, when calcium oxide and calcium hydroxide are included in the pellets, the calcium hydroxide can impart enhanced anti-strip and improved aggregate-asphalt cement bonding, and the calcium oxide can interact with any absorbed water in order to yield additional calcium hydroxide. Also, it can be economically favorable for the hydration reaction that converts quicklime to hydrated lime to be incomplete so that some amount of quicklime remains. Allowing some amount of quicklime to remain and be included in the pellets can enable the pellets to be prepared with novel methods as described herein. Accordingly, the inventive pellets can include lime in a variety of concentrations such as those recited for calcium hydroxide.

In one embodiment, it can be economically favorable to prepare pellets that include lime and additionally include some limestone. This can be favorable so that the reaction process that converts limestone into quicklime can be conducted until some amount of limestone is converted to quicklime; however, some amount of limestone is retained. Preferably, the majority of the pellets include lime, and any limestone is present in a minor amount. Also, some amount of limestone can be included in the pellets because the limestone may not substantially affect the asphalt. Additionally, it is thought that some amount of limestone may be beneficial for asphalt conditioning applications.

In one embodiment, it can be preferred for the pellets to be substantially devoid of limestone. While some applications can allow for the pellets to include some amount of limestone, there are other applications where it may be preferred that the pellets are substantially devoid of limestone. For example, an asphalt manufacturing protocol may be utilized where it is undesirable to have limestone in the pellets because of the intended use of the pellets.

E. Fines

The asphalt pellets can be prepared to include fines other than lime or include other fines with lime. Any material that can be prepared into fines can be used to prepare the asphalt pellets. While materials such as metals, metal alloys, composites, ceramics, exotic materials, and the like are not traditionally included in asphalt, such materials can be included in the asphalt pellets as fines. These materials can provide filler for adherence of the asphalt and/or other binder so as to form the pellets. Also, these materials can be used as filler in the asphalt compositions and asphalt pavement. It is preferable for the fines to be asphalt-compatible so that they can be included in an asphalt composition that is suitable for use in asphalt pavement so as to comply with any regulation governing the preparation of asphalt pavement. Examples of ceramics can include oxides, aluminas, zirconias, non-oxides, carbides, nitrides, silicides, composites, barium titanates, strontium titanates, bismuth strontium calcium copper oxides, boron nitrides, ferrites, lead zirconates tatanates, magnesium diborides, silicon aluminum oxynitrides, silicon carbides, silicon nitrides, steatites, titanium carbides, yttrium barium copper oxides, zinc oxides, zirconium dioxides, combinations thereof, and the like. The metals and alloys can be any type of metal or alloy.

In one embodiment, the fines are rock and/or mineral fines. Rock or mineral fines can be obtained from any type of rock or mineral that is crushed and pulverized into finely divided materials. Often, rock or mineral fines can be considered rock dust or mineral dust that is obtained from industrial processes as a side product and even include recycled asphalt pavement fines from recycled pavements. For example, old asphalt pavement can be processed into fines, and then formed into asphalt pellets with a binder as described herein. Also, rock fines or mineral fines can be specifically prepared to have a small enough size to be useful in preparing the asphalt pellets. General examples of rock fines, includes fines of igneous, sedimentary, and/or metamorphic rocks. Specific examples of rock fines and/or mineral fines can include olivines, pyroxenes, plagioclases, amphiboles, muscovites, biotites, quartzes, potash felspars, clastics, conglomerates, gravels, breccias, sand clastics, sandstones, calcium rocks, silica rocks, siltstones, claystones, mudstones, shale, evaporites, halites, gypsums, anhydrites, calcites, argonites, dolomites, travertines, tufas, oolites, cherts, flints, jaspers, marbles, micas, chlorites, graphites, hornblendes staurolites, pyroxenes, slates, phyllites, schists, gneisses, actinolites, tourmalines, migmatites, granites, pyrolusites, limonites, hematites, galenas, silvers, golds, mournites, coppers, chalcopyrites, chromites, magnetites, pyrites, talcs, montmorillonites, bauxites, kaolinites, serpentines, sphalerites, siderites, fluorites, apatites, kyanites, orthoclase felspars, plagiolase feldspars, garnets, micro-crystalline quartz, beryls, topazes, corundums, diamonds, combinations thereof, and the like.

The pellets can include fines in a variety of concentrations. Some embodiments can include fines as low as about 0.5% by weight and up to about 30% by weight of the pellet. For example, the pellets can include fines from about 1% to about 30%, more preferably from about 2% to about 25%, even more preferably from about 5% to about 20%, and most preferably from about 6% to about 15% by total weight of the pellet. These amounts of fines can be for any type of fines, including lime and/or recycled asphalt fines.

In an embodiment of an asphalt pellet configured for being used in preparing asphalt paving compositions and asphalt pavement, it can be preferred to include the fines at lower quantities so that the majority of the pellet is asphalt, rubberized asphalt, or an asphalt/rubber combination. As such, it can be beneficial to have a pellet with fines being about 0.5% about 30% by weight of the total pellet, preferably about 1% to about 20% by weight of the total pellet, and more preferably about 1% to about 10% by weight of the total pellet. In another embodiment, the fines can be minimal or less than or about 1% of the total pellet, preferably less than or about 0.75% of the total pellet, and most preferably less than or about 0.5% of the total pellet. In some instances, the pellets are devoid of fines. Also, the amount of fines can be in the core and/or in the shell. That is, some embodiments do not have an appreciable amount of fines (e.g, less than 0.1%) in either the core, shell, or both.

In one embodiment, the pellets are devoid or substantially devoid of lime and include other types of fines. The amount of fines can be the amount in the core of the asphalt pellet. Alternatively, the amount of fines can be the amount of the shell. In another alternative, the amount of fines can be the amount in the core and shell.

F. Non-Bituminous Binders

In one embodiment, the binder can be a hydrophobic polymer that is not bitumen or asphalt based. As such, the hydrophobic binder can be polymer comprised of acrylic acids, methacrylic acids and copolymers, methyl methacrylate copolymers, ethoxyethyl methacrylates, cynaoethyl methacrylate, aminoalkyl methacrylate copolymer, poly(acrylic acid), poly(methacrylic acid), methacrylic acid alkylamide copolymer, poly(methyl methacrylate), poly(methacrylic acid) (anhydride), methyl methacrylate, polymethacrylate, poly(methyl methacrylate), poly(methyl methacrylate) copolymer, polyacrylamide, aminoalkyl methacrylate copolymer, poly(methacrylic acid anhydride), glycidyl methacrylate copolymers, polyolefins, silicones, polypropylenes, polyethylenes, acrylic polymers, polystyrenes, polyethylene-vinyl acetate, polyethylene vinyl alcohol, polyethylene acetate, polyvinylpyrrolidones, chlorinated polyethylenes, polyisoprenes, polybutadienes, styrene-butadiene di- and tri-block polymers, polychloroprenes, polyethylene-propylenes, chlorosulfonated polyethylenes, polyurethanes, styrene isoprene polymers, styrene ethylbutylene polymers, styrene butadiene rubber latex, other rubbers, polychloroprene latex, polymethylmethacrylate, polyethylmethacrylate, polydimethylsiloxanes, and the like.

In one embodimetnt, the non-bituminous binder is a hydrophobic cellulosic material such as ethylcellulose. Those skilled in the art will appreciate that other cellulosic polymers, including other alkyl cellulosic polymers, may be substituted for part or all of the ethylcellulose included in the hydrophobic polymer portion of the multiparticulates of the present invention. Also, the binder can be hydroxyalkylcelluloses such as hydroxypropylmethylcellulose and mixtures thereof.

In one embodiment, the non-bituminous binder can be an organic binder. Examples of organic binders include polyolefins, silicones, acrylics, latexes, waxes, oils, greases, plasticizers, lignosulfonates, polysaccharides, celluloses and derivatives thereof, starches and derivatives thereof, other natural polymers (e.g., proteins), natural and synthetic rubbers, and the like.

In one embodiment, the non-bituminous binder is a hydrophilic binder. Hydrophilic binders are characterized as being compatible with water systems, and thereby can be used in soil applications, and may be useful for asphalt applications. Hydrophilic binders can be polymeric and can include hydrophilic monomers. Examples of hydrophilic binders include asphalt emulsions, inverted asphalt emulsions, polyethylene glycol, polyetheleneimine, polylysine, polysaccharides, and the like.

In one embodiment, the non-bituminous binder is a biodegradable polymer. For example, the biodegradable polymer composition can include poly(alpha-hydroxy esters), polylactic acids, polylactides, poly-L-lactide, poly-DL-lactide, poly-L-lactide-co-DL-lactide, polyglycolic acids, polyglycolide, polylactic-co-glycolic acids, polyglycolide-co-lactide, polyglycolide-co-DL-lactide, polyglycolide-co-L-lactide, polyanhydrides, polyanhydride-co-imides, polyesters, polyorthoesters, polycaprolactones, polyesters, polyanydrides, polyphosphazenes, polyester amides, polyester urethanes, polycarbonates, polytrimethylene carbonates, polyglycolide-co-trimethylene carbonates, poly(PBA-carbonates), polyfumarates, polypropylene fumarate, poly(p-dioxanone), polyhydroxyalkanoates, polyamino acids, poly-L-tyrosines, poly(beta-hydroxybutyrate), polyhydroxybutyrate-hydroxyvaleric acids, combinations thereof, or the like.

In one embodiment, the non-bituminous binder is a natural polymer that can be derived from a natural source. Natural polymers can include polysaccharides, proteins, and the like. Examples of some suitable polysaccharides include methylhydroxyethylcellulose, hydroxymethylethylcellulose, carboxymethylcellulose, methylcellulose, ethylcellulose, hydroxyethylcellulose, hydroxyethylpropylcellulose, amylopectin, amylose, seagel, starches, starch acetates, starch hydroxyethyl ethers, ionic starches, long-chain alkylstarches, dextrins, amine starches, phosphate starches, and dialdehyde starches, alginic acid, phycocolloids, agar, gum arabic, guar gum, locust bean gum, gum karaya, gum tragacanth, poultry eggs, blood, and the like.

In one embodiment, the non-bituminous binder is comprised of lignin and/or lignosulfonate or acid thereof. Lignin is a wood constituent that is modified in a sulfite pulping process in order to obtain lignosulfonate. When used as a binder, the lignin and/or lignosulfonate can be used at the general binder compositions, or at any concentration less than about 99% by weight or greater than about 0.5% by weight, more preferably from about 0.75% to about 50%, even more preferably from about 1% to about 20%, and most preferably from about 1.25% to about 10% by weight of the binder.

In one embodiment, the non-bituminous binder can include a polysaccharide or modified polysaccharide. It has now been found that such polysaccharides or modified polysaccharides can be used as binders. Examples of polysaccharide or modified polysaccharide binders include starch, gelatinized starch, celluloses such as carboxymethylcellulose, and liquid modified starches obtained from mashing and brewing processes such as Brewex™ (Mars Mineral; Mars, Pa.).

In another embodiment, tannin liquor compositions can be used as the binder. Such tannin liquors can be obtained from processes used to convert animal skin into leather, but can also include large polyphenolic compounds. For example, a tannin liquor can include a vegetable tannin such as TAC™ (Mars Mineral; Mars, Pa.).

In another embodiment, collagen or collagen derivatives can be used as the binder. Such collagen derivatives particularly suitable for preparing pellets can be obtained from leather production waste, wherein the collagen or derivative thereof has been reduced to polypeptides. For example, the collagen derivatives can include Collagen CH₂™ (Mars Mineral; Mars, Pa.).

In another embodiment, a beet molasses derivative can be used as the binder. Usually, such a beet molasses derivative has a reduced sugar content, as the sugar has been previously extracted. An example of such a reduced-sugar beet molasses is Molex™ (Mars Mineral; Mars, Pa.).

In one embodiment, latex can be used as a binder and/or used as an adhesive additive. In part, the benefits arise from the composition of latex, which includes an emulsion of a synthetic rubber or plastic obtained by polymerization. Also, the benefits may be realized for the same reasons latex is used in coatings, paints, and adhesives. When used as a binder, latex can be used within the general binder concentrations. In asphalt applications, latex can be used at less than about 30% by weight of the pellet, more preferably less than about 20% by weight, and most preferably less than 10% by total weight. Latex can also be used to form a shell around the pellet.

In some instances it can be preferred that a certain polymer is used as a binder and/or adhesive additive. Some polymers have been previously used as asphalt additives or conditioners, and are typically classified as elastomers or plastomers. It has now been found that such polymers can be used as binders so as to provide a pellet. Elastomers include copolymers of styrene and butadiene, styrene-butadiene diblock, styrene-butadiene-styrene triblock or radial, styrene isoprene, styrene ethylbutylene, styrene butadiene rubber latex, polychloroprene latex, polyisoprene, and crumb rubber modifier (e.g., crumb rubber is an asphalt modifier). Plastomers include polyethylene vinyl acetate, polyethylene vinyl alcohol, polyethylene acetate, polyethylene and its derivatives, and various compounds based on polypropylene. Additionally, other types of polymers that can be used include acrylic polymers such as polymethylmethacrylate and polyethylmethacrylate, silicon-based polymers such as polydimethylsiloxane, and the like. When used as a binder, a polymer can be used at the general binder concentrations. These polymers may also be used as coatings. In asphalt applications, a polymer can be used at less than about 30% by weight of the pellet, more preferably less than about 10% by weight, and most preferably less than 3% by total weight.

Further, various other compounds can be used as, or with, asphalt-compatible binders. Bentonite clay and vermiculite in solution can also be used as binders. Accordingly, adhesive additives can either be used as the binder or an additive. Some examples of such adhesive additives include high temperature silicones, which are stable at high temperatures. These materials can bind fines into pellets, or complement another binder such as bitumen. Also, silicone-based polymers, methyltrimethoxysilane, and trimethoxysilyl compounds can be similarly used.

Additionally, various combinations of the foregoing binders can be employed in manufacturing a pellet. As such, the properties provided by different properties can be combined so as to form a pellet that is compatible with asphalt, and can improve the physical properties thereof.

The binders can also be included in binder liquids, emulsions, and/or suspensions. The binder emulsions can be prepared to include cationic or anionic asphalt emulsions, sugar emulsions, starch emulsions, organic emulsions, soy emulsions, lard emulsions, clay emulsions, and the like. The binder liquids can be prepared by any process to liquefy the binder. Binder suspensions can be prepared by suspending the binder in a liquid such as water or another solvent. In any event, any of the binders can be prepared into binder liquids, emulsions, and/or suspension with or without water or other solvent.

In one embodiment, the binder can be prepared from asphalt, rubber (e.g., tire rubber or crumb rubber), and sasol wax. The binder these three components can be prepared at any of the percentages described in connection with the asphalt/rubber binder with the rubber and sasol making up the difference from the given amount of asphalt. Sasol and rubber asphalt oil can be combined at about 10% to about 90%, more preferably from about 5% to about 95% more preferably, and most preferably both at about 2% to 98% asphalt rubber cement. Sasol can be beneficial as an asphalt modifier in preparing asphalt compositions and asphalt pavement because it can lower the asphalt hot mix production and roadway processing temperature from about 325 to 300 degrees F. to about 280 to 250 degree F., which is considered medium mix asphalt. The wax also is beneficial as the coating to form the shell, such as by one or more layers.

G. Solvents

In one embodiment, it can be beneficial to use a solvent during the manufacture of the pellets. The solvent can be used for improving the binder's flow characteristics or for enhancing the interactions between the fines and binder or the pellets chemical interface with the asphalt oil/aggregate. Also, the solvents can be used in order to suspend the fines in the binder or other ingredients so as to enhance its handling and processing ability. For example, it can be beneficial to pre-treat the fines with a solvent so that the problems associated with airborne particulates can be avoided and the particles can interface with the asphalt oil. In another example, it can be beneficial to mix the binder and additives with the solvent for delivery to the ground rubber or fines. Some solvents are retained in the pellets after being manufactured.

When the binder is hydrophilic or water-soluble, it can be beneficial to suspend or dissolve the binder in water or other aqueous solvent so that it can be thoroughly and homogeneously combined with the fines. However, water can also be used with hydrophobic binders in preparing emulsions and/or suspensions. Also, water or aqueous solvent can provide a medium for transporting and handling the fines so as to prevent or limit the problems associated with such fine particulates (e.g., problems with lime and recycled asphalt fines). After adequate mixing, water can be blown off or evaporated so that the binder-fines mixture can be further processed. Additionally, the water can be used to hydrate the quicklime into hydrated lime before or during the lime interminglinged with the binder.

When the binder is hydrophobic, it can be beneficial to suspend or dissolve the binder and/or fines in a hydrophobic solvent. The hydrophobic solvent can be favorable and useful for hydrophobic binders as water is useful for with hydrophilphobic binders. However, hydrophobic solvents may need to be utilized in combination with a water treatment in order to hydrate the quicklime into the hydrated lime. As such, the hydrophobic solvent can be combined with water, or can be provided separately from water depending on the process.

In some instances, it can be beneficial for the solvent to include an organic solvent. This can facilitate combining the binder with the fines during some of the various methods for manufacturing the fines. In some instances, portions of the organic solvent can be retained in the pellet as an additional conditioner or plasticizer for the binder. Otherwise the organic solvent can be blown off, especially when a volatile solvent such as ethanol or isopropanol is used. Some examples of organic solvents include toluene, hexane, aliphatic petroleum distillate, alicyclic hydrocarbons, aromatic hydrocarbons, standard solvents, acetone, ethanol, isopropanol, and the like.

Additionally, the solvents can be comprised of detergents and/or surfactants that alter the surface tension and can allow for enhanced interaction of the binder and fines. Accordingly, a detergent and/or surfactant can be selected based on the properties of the primary solvent and/or binder. That is, aqueous solvents can be used with some detergents and/or surfactants, and non-aqueous solvents may be used with the same or different detergents and/or surfactants similar to Akzo Nobel's Ethoduomeen T/13. The process of selecting detergents and/or surfactants based on the solvent and other components (e.g., lime) is well known to be based on the properties of the substances to be included in the composition as well as the desired properties of the resulting composition.

H. Additives

The asphalt pellets in accordance with the present invention can include a variety of additional additives for asphalt or soil conditioning applications. One such additive can include a structural additive such as sand, silica, fly ash, ceramic particles, glass particles, clay particles, pozzolanic materials, anti-stripping agents, fertilizer, nutrients filler materials, and the like. Accordingly, pellets that are prepared for use in asphalt applications can include additives that are customarily included in asphalt pavement and/or asphalt products.

Another type of additive includes an agent that can impart a color to the asphalt pellet. For example, carbon black and/or manganese oxide can be included so as to impart a dark or black color to a pellet that is configured for use with asphalt.

An additional type of additive includes salts which can interact with many of the components in the pellet and enhance the long-term characteristics of the pellet, asphalt pavement, and/or soil. In fact, some of the salts can act to enhance the binders when processed with the fines. Examples of such salts include sodium chloride, calcium chloride, potassium chloride, magnesium sulfate, manganese dioxide, manganese oxide, and the like. The salt additive can be present at a concentration ranging from about 0.1% to about 20% by weight, more preferably from about 0.25% to about 15%, and most preferably from about 0.5% to about 10% by weight.

In order to change the rheology of the compositions that are used in preparing the pellet, a rheology-modifier can be used. When a shear force is applied to a composition having a rheology-modifier, it can behave in a non-Newtonian manner so that the viscosity decreases by the applied force. This can be beneficial for homogeneously distributing fines throughout a composition during the mixing, and then inhibiting or decreasing the settling of the fines after the composition is allowed to set. Also, rheology-modifiers can be lime binders. Examples of such rheology-modifiers include polysaccharides such as caroboxymethylcellulose, other celluloses, amyloses, inulins, chitins, chitosans, amylopectins, glycogens, pectins, hemicelluloses, glucomannans, galactoglucomannans, xyloglucans, methylglucuronoxylans, arabinoxylans, methylglucuronoarabinoxylans, glycosaminoglycans, chondroitins, hyaluronic acids, alginic acids, and the like.

In instances a polymer is used as a binder, adhesive, or other additive in the pellets, a plasticizer can be used to enhance the characteristics of the pellet. Examples of suitable plasticizers include water-insoluble plasticizers such as dibutyl sebacate, diethyl phthalate, triethyl citrate, tributyl citrate, triacetin, acetylated monoglycerides, phthalate esters, castor oil, dibutyl phthalate, 1,2-propylene glycol, polyethylene glycols, propylene glycol, and the like.

### IV. Manufacturing Pellets

In one embodiment, a rubberized asphalt pellet is paving grade asphalt and rubber as a core with a water-resistant polymer or wax coating. Alternatively, fines can be used as the shell coating. The rubberized asphalt pellet can be prepared by mixing a paving grade asphalt and ground tire rubber or other rubber source, and heating the composition to be liquefied for a duration of 45 minutes or more. The composition is then processed into small pellet sizes and coated with the polymer, wax, or fines coating. Such processing can include cooling the asphalt-rubber composition and then extruding, cutting, or otherwise forming pellet cores that are then coated to form the shell to create the pellets.

In the embodiment that is substantially devoid of fines in the core, the rubberized asphalt can be prepared as a core and a shell. The core can include ground tire rubber from about 15% to about 30% by weight of the core, and pavement grade asphalt from about 85% to about 70% by weight of the core. Alternatively, the core can include from about 17% to about 28% or from about 20 to about 26% ground tire rubber, and from about 83% to about 72% or from about 80% to about 74% pavement grade asphalt. The shell can coat the core such that the pellet has a maximum dimension of about 1/16 inch to about 2 inches. The composition of the shell can be a water-resistant polymer or wax, or it can be a coating of fines.

In one embodiment, the rubberized pellet that is substantially devoid of fines in the core can be characterized by one or more of the following: the ground tire rubber at about 15% to about 26% by weight of the total pellet, about 17% to about 23%, or about 19% to about 21%; the pavement grade asphalt at about 40% to 70% by weight of the total pellet, 50% to about 60% by weight of the total pellet, or about 54% to about 56% by weight of the total pellet; the core having less than about 10% by weight being sulfur; the fines are lime fines at less than about 25% by weight of the total pellet; or the coating is wax. The percentages by weight of the total pellet can also be by weight of the total core, so as to exclude the amount of materials in the shell.

In one embodiment, the asphalt pellet is prepared with a rubberized asphalt binder and fines. The asphalt and rubber are combined and heated for 45 minutes or longer, and then combined and mixed with the fines, which then are prepared into pellet cores. The pellets are then coated with the polymer, wax, or fines coating to form a core and shell pellet. The rubberized asphalt binder can include other binders described herein in minority concentrations so that the majority of the binder is asphalt. As such, the asphalt pellets can be used as an important ingredient in asphalt paving compositions and methods of preparing the same as well as preparing asphalt pavement.

The rubberized asphalt pellet can include a core with an asphalt-based binder at about 70% to about 99% by weight of the core, 70% to about 95%, 70% to about 85%, or other similar amount. The core can include fines at greater than 1%, but less than about 30%, less than about 25%, less than about 20%, less than about 15%, and less than about 10% fines. The asphalt-based binder can be prepared to include: ground tire rubber from about 15% to about 30% by weight of the asphalt-based binder, about 17% to about 28%, and about 22% to about 27% or about 26% by weight of the asphalt-based binder, with the balance being pavement grade asphalt. For example, the pavement grade asphalt from about 85% to about 70% by weight of the asphalt-based binder or about 74% when the rubber is about 26%. The core can include fines at about 30% to about 1% by weight of the core or other amount described herein. The shell coating the core can provide the pellet with a maximum dimension of about 1/16 inch to about 2 inches. The shell can include a water-resistant polymer or wax, or a coating of fines. In one aspect, the fines are lime fines or ground asphalt pavement fines. Optionally, the fines can be mineral or rock fines as described herein.

In one embodiment, the rubberized pellet is characterized by one or more of the following: the ground tire rubber at about 15% to about 25% by weight of the total pellet; the pavement grade asphalt at about 50% to about 60% by weight of the total pellet; the core having less than about 10% by weight being sulfur; the fines are lime fines at less than about 25% by weight of the total pellet; or the coating is wax.

In one embodiment, the pellet can be characterized by one or more of the following: the ground tire rubber from about 20% to about 26% by weight of the asphalt-based binder; the pavement grade asphalt from about 74% to about 80% by weight of the asphalt based binder; or the fines are lime fines at less than about 25% by weight of the total pellet.

In one embodiment, the binder is a rubberized asphalt binder that includes asphalt and tire rubber or tire rubber components. That is, tire rubber components can be substituted for tire rubber in some instances. The asphalt and tire rubber, such as ground tire rubber or crumb rubber, is processed by heating for a time to prepare a sticky composition that adheres to the fines so as to form a pellet. For example, the asphalt and rubber are mixed together and heated at a high temperature (e.g., about 350 to about 380 degrees) for about 45 minutes to about 1 hour or as sufficient. The asphalt and tire rubber can be mixed at various ratios; however, it can be preferred that the asphalt is the major component and the tire rubber is the minor component.

A specific example includes about 74% asphalt and 26% rubber, and a pellet prepared therefrom can be let down with about 1-2% bitumen or asphalt at the asphalt hot mix manufacturing plant. Another specific example includes about 90% asphalt and about 10% rubber (or relative percentages that can be let down to these percentages) because of regulations mandating a minimum of 10% rubber in asphalt pavements.

Generally, the present invention includes methods of manufacturing asphalt pellets to include an asphalt-based binder and fines. The fines are provided in an amount to be stuck together and agglomerated by the asphalt-based binder. Also, the fines are provided in an amount to achieve a pellet product that is storage stable as described herein. Optionally, a coating can be applied to the pellets to obtain pellets having a shell and core configuration.

A. Lime Pellets

The present invention includes manufacturing lime-containing rubberized asphalt pellets for use in asphalt manufacturing conditioning. Such manufacturing includes the following: heating limestone (CaCO₃) to obtain quicklime (CaO); hydrating the quicklime with an aqueous binder solution to obtain hydrated lime (Ca(OH)₂); and pelletizing the hydrated lime into rubberized asphalt pellets that include the hydrated lime bound with the rubberized asphalt binder.

In one embodiment, the method of manufacturing lime-containing rubberized asphalt pellets for use in asphalt manufacturing includes the following: heating limestone (CaCO₃) to obtain quicklime (CaO); hydrating the quicklime with an aqueous solution to obtain hydrated lime (Ca(OH)₂) mixture that includes water; and pelletizing the hydrated lime mixture into rubberized asphalt pellets that include the hydrated lime bound with a rubberized asphalt binder, wherein the hydrated lime is not dried or converted to a powder prior to the pelletizing with the binder.

In one embodiment, the method of manufacturing lime-containing rubberized asphalt pellets for use in asphalt includes the following: obtaining crushed limestone (CaCO₃) fines; heating the limestone fines to a temperature of at least about 825° C. to release CO₂ and obtain quicklime (CaO) fines; hydrating the quicklime fines with an aqueous solution to obtain a suspension of hydrated lime (Ca(OH)₂) fines; and pelletizing the hydrated lime into rubberized asphalt pellets that include hydrated lime fines bound together with the rubberized asphalt binder.

In one embodiment, the hydrating can be performed with pure or substantially pure water, and the binder can be added separately. This can include the water hydrating the quicklime into hydrated lime before the binder is included, or the binder can be added while the hydration reaction is converting the quicklime to hydrated lime. As such, the duration between adding the water and binder can be modulated to obtain varying degrees of hydration, such as partial through full hydration. Also, the water can continue to hydrate the lime after being bound by the binder.

In one embodiment, the method includes crushing the limestone into a limestone powder before being heated into quicklime. Such crushing can be performed by any technique and with any equipment that can crush limestone rocks into limestone pebbles, powdered limestone, limestone fines, combinations thereof, and the like. For example, a rock crusher can be used to pulverize limestone rocks into smaller pieces of limestone, which usually includes limestone dust or fines generated from the process. Alternatively, a rock crusher can be used to pulverize the limestone rocks into a limestone powder that includes limestone fines and optionally some limestone pebbles; however, limestone fines are preferred.

In one embodiment, the method includes cooking the limestone into quicklime within a heating apparatus. Limestone is known to be converted into quicklime by being cooked at temperatures of about 825° C. or a temperature that drives off the carbon gas so that calcium oxide is formed. However, it can be beneficial to heat the limestone to at least about 875° C., preferably to at least about 900° C., more preferably to at least about 950° C., and most preferably to at least 1000° C. These higher temperatures can help drive off other substances so as to obtain quicklime that has less additional substances contained therein.

B. General Asphalt Pellets

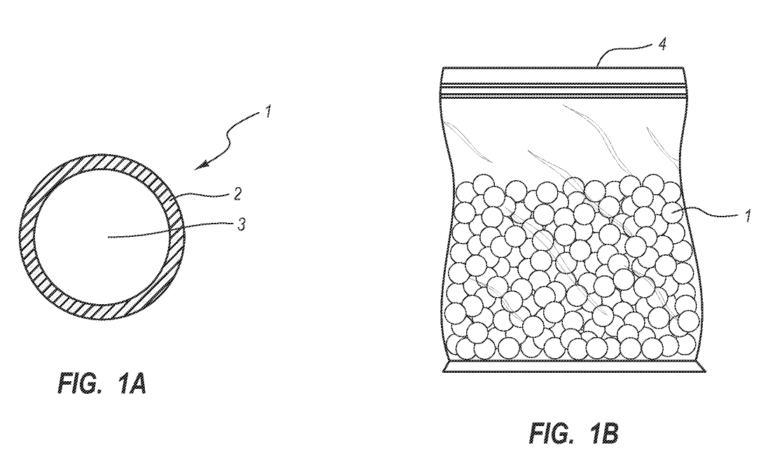

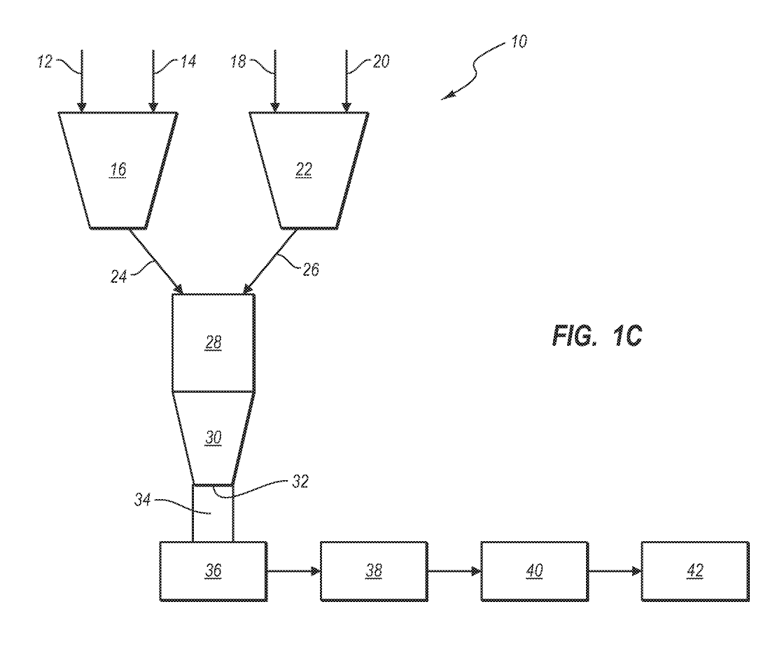

FIGS. 1-4 illustrate various schematic diagrams of embodiments of processing systems and equipment that can be used during the formation of a rubberized asphalt pellet. It should be recognized that these are only examples or schematic representations of processing systems and equipment, and various modifications can be made in order to prepare the rubberized asphalt pellets. Also, the schematic representations should not be construed in any limiting manner to the arrangement, shape, size, orientation, or presence of any of the features described in connection with the figures. With that said, a more detailed description of examples of some of the systems and equipment that can prepare asphalt paving pellets is provided below.

FIG. 1B depicts an embodiment of a pelleting system 10 in accordance with the present invention. Such a pelleting system 10 includes a first mixer 16, second mixer 22, extruder 28, dye head 30, cooler or dryer 36, pelletizer 38, conditioning apparatus 40, and pellet collector 42.

The first mixer 16 is configured to receive a first feed of materials through a first feed line 12 and a second feed of materials through a second feed line 14. The first mixer 16 processes the materials supplied by the first line 12 and second line 14 into a first mixture 24. Similarly, an optional second mixer 22 has a third feed line 18 and a fourth feed line 20 that supplies the material to be mixed into a second mixture 26. The first mixer 16 and/or the second mixer 18 can be configured for variable speed and shear mixing at elevated temperatures.

For example, the first feed line 12 can supply the fines with or without a solvent, and the second feed line 14 can supply the binder (e.g., asphalt binder, asphalt/rubber binder, asphalt/rubber/sasol binder etc.) with or without a solvent that can be sprayed onto or otherwise combined with the fines. Additionally, the third feed line 18 can supply the fines (e.g., the same fines or different fines) with or without a solvent, and the fourth feed line 20 can supply the same or a different binder with or without a solvent. The second mixer 22 is optional because it can be preferable to prepare pellets with only one type of fines or all of the fines can be mixed with binder together in one mixer. Additionally, other processing schemes can render the second mixer as optional.

Additionally, the first mixture 24 and the second mixture 26 are supplied into the extruder 28, and mixed into a composition capable of being extruded. Additionally, while being mixed, the composition can be moved through the extruder 28 so as to pass by heating elements (not shown). The heating elements can provide for a ramped increase or parabolic change in temperature in order to gradually remove the solvents and/or increase the liquidity of the binder before extrusion.

As the composition moves to the end of the extruder 28, it passes through the die head 30 before being extruded through the die opening 32. The die head 30 and die opening 32 can be configured into any shape or arrangement so long as to produce a pelletable extrudate 34. In another embodiment, the extrudate 34 can itself form pellet-sized spheroids by having a plurality of die openings 32 in the die head 30.

In some instances when the extrudate 34 leaves the die opening 32, it can be too moist or too hot to be pelleted. As such, it can be beneficial to dry the extrudate 34 in an optional dryer and/or chiller 36 before being pelleted to remove any solvent or cool the pellets prior to the coating operation. The dried extrudate can have a moisture content below about 10%, more preferably below about 5%, and most preferably below about 2% before being pelleted.

Accordingly, the pellets can be dried by air drying or with a mechanical dryer. The pellets can also be cooled by air cooling of a chiller device similar to a refrigerant device used in processing thermo plastics or other thixotropic materials. The mechanical dryer can be any drying apparatus configured to use heat to remove moisture, such as a continuous flow rotary dryer or the like. The drying temperature can be at least about 100° C., preferably at least about 150° C., more preferably at least about 200° C., and most preferably at least about 250° C. Conversley, the need to cool the pellet to ambient temperatures is desirtable before extruding or coating the asphalt paving pellets.

On the other hand, the extrudate 34 may be at an elevated temperature from the extruding process so as to have thermoplastic characteristics (i.e., being in a flowable or gummy state). As such, it can be beneficial to cool the extrudate 34 before pelleting. For example, the extrudate can be cooled to a temperature of less than 35° C., more preferably a temperature less than 30° C., and most preferably less than 25° C. in the cooling apparatus 36 before being pelleted.

After the extrudate 34 is dried or cooled, it is supplied to the pelletizer 38. The pelletizer 38 can be configured for cutting the extrudate 34 into a variety of shapes and sizes, such as those described herein. For example, the extrudate 34 can be cut into pellets having a diameter range from about 1.5 mm (about 0.05 inches) to about 2.54 cm (about 1 inch), more preferably in a range of from about 2 mm (about 0.08 inches) to about 2 cm (about 0.8 inches), even more preferably about 3 mm (about 0.1 inches) to about 1.5 cm (about 0.6 inches), and most preferably in a range of from about 6 mm (about 0.2 inches) to about 1 cm (about 0.4 inches).

The pellets can then be supplied from the pelletizer 38 to an optional conditioning assembly 40, which can condition the pellets for storage in a pellet collector 42, or for further processing. For example, the conditioning assembly 40 can be configured to harden the pellets, apply a water-resistant coating such as a water-resistant polymer or a wax, or apply a lubricious coating so as to reduce the friction between the pellets. Alternatively, it can apply fines as a coating. The coating can provide the shell and core pellets described herein. Also, any of the equipment for use in processing the pellets can be combined together for simplicity.

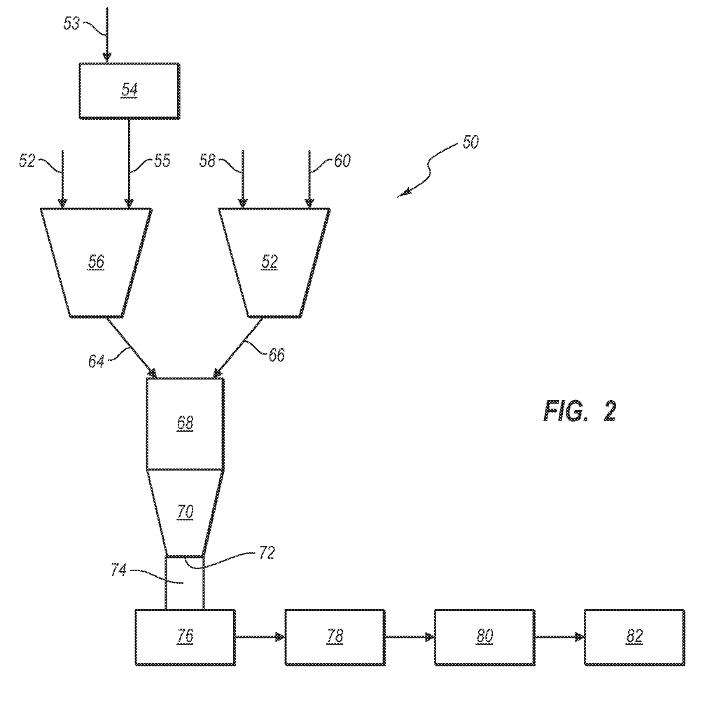

FIG. 2 depicts an embodiment of a pelleting system 50 in accordance with the present invention. Such a pelleting system 50 includes a heater 56 (e.g., heater or mixer), optional rock crusher 54, mixer 62, extruder 68, dye head 70, cooler or dryer 76, pelletizer 78, conditioning apparatus 80, and pellet collector 82.

The heater/mixer 56 is configured to receive a feed of crushed rock (e.g., recycled asphalt pavement, mineral fines or limestone fines) through a first feed line 52. The heater 56 is configured to cook limestone so as to convert the limestone from being calcium carbonate to quicklime, or configured to mix rushed rock with binder. As such, the heater 56 can achieve temperatures in excess of 825° C. in order to drive carbon gas from the limestone. The quicklime can then be provided as a supply of quicklime fines 64 for further processing. Alternatively, the heater can simply be a supply of fines of any material that can be provided as fines 64.

Optionally, the pelleting system includes a rock crusher 54 that is configured to receive rocks 53 and crush the rocks to a much smaller size, such as the size of fines. That is, the rock crusher 54 can crush the rocks into smaller rocks, pebbles, grains, powders and the like so that the crushed limestone can be provided as crushed rock 55 into the mixer 56. The rock crusher 54 is optional because fines can be obtained as fines.

The mixer 62 has an asphalt feed line 58 and a ground tire rubber feed line 60 that supplies the ingredients to prepare rubberized asphalt to be mixed into a rubberized asphalt binder mixture 66. The mixer 62 can be configured for variable speed and shear mixing at elevated temperatures as described herein. As such, the mixer 62 can be any type of mixer that can mix asphalt and ground tire rubber or other rubber into a binder. Also, the mixer 62 can include heating elements so that the mixing can be conducted at an elevated temperature as needed.

The fines 64 and rubberized asphalt binder mixture 66 are supplied into the extruder 68, and mixed into a composition capable of being extruded. For example, the binder can be sprayed, soaked, squirted, streamed, dripped, or otherwise added onto the fines. As such, when the fines 64 intermingle with the rubberized asphalt binder mixture 66.

Optionally, while being mixed, the fines and rubberized asphalt binder composition can be moved through the extruder 68 so as to pass by heating elements (not shown). The heating elements can provide for a ramped increase or parabolic change in temperature in order to gradually remove the solvents and/or increase the liquidity of the binder before extrusion. While the hydrating reaction is exothermic, the heating elements may additionally increase the temperature of some binders so that the binder is sticky or capable of binding the lime fines together. This can be especially favorable for rubber binders.

As the fines/binder composition moves to the end of the extruder 68, it passes through the die head 70 before being extruded through the die opening 72. The die head 70 and die opening 72 can be configured into any shape or arrangement so long as to produce a pelletable extrudate 74. In another embodiment, the extrudate 74 can itself form pellet-sized spheroids by having a plurality of die openings 72 in the die head 70, which is properly configured as is well known in the art.

In some instances when the extrudate 74 leaves the die opening 72, it can be too moist to be pelleted. As such, it can be beneficial to dry the extrudate 74 in an optional dryer 76 before being pelleted to remove any solvent. The dried extrudate can have a moisture content below about 15%, more preferably below about 10%, and most preferably below about 5% before being pelleted.

On the other hand, the extrudate 74 may be at an elevated temperature from the extruding process so as to have thermoplastic characteristics (i.e., being in a flowable or gummy state). As such, it can be beneficial to cool the extrudate 74 before pelleting. For example, the extrudate can be cooled to a temperature of less than 35° C., more preferably a temperature less than about 30° C., and most preferably less than 25° C. in the cooling apparatus 76 before being pelleted.

After the extrudate 74 is dried and/or cooled, it is supplied to the pelletizer 78. The pelletizer 78 can be configured for cutting the extrudate 34 into a variety of shapes and sizes. For example, the hydrated lime extrudate 74 can be cut into pellets having a diameter as described herein, such as a range from about 1.5 mm (about 0.05 inches) to about 2.54 cm (about 1 inch), more preferably in a range of from about 2 mm (about 0.08 inches) to about 2 cm (about 0.8 inches), even more preferably about 3 mm (about 0.1 inches) to about 1.5 cm (about 0.6 inches), and most preferably in a range of from about 6 mm (about 0.2 inches) to about 1 cm (about 0.4 inches).

The pellets can then be supplied from the pelletizer 78 to a conditioning assembly 80, which can condition the pellets for storage in a pellet collector 82, or for further processing. For example, the conditioning assembly 80 can be configured to harden the pellets, apply a water-resistant coating such as a water-resistant polymer (e.g., PVA) or a wax (e.g., sasol wax), or apply a lubricious coating so as to reduce the friction between the pellets. The conditioning assembly 80 can also apply fines for the shell coating.

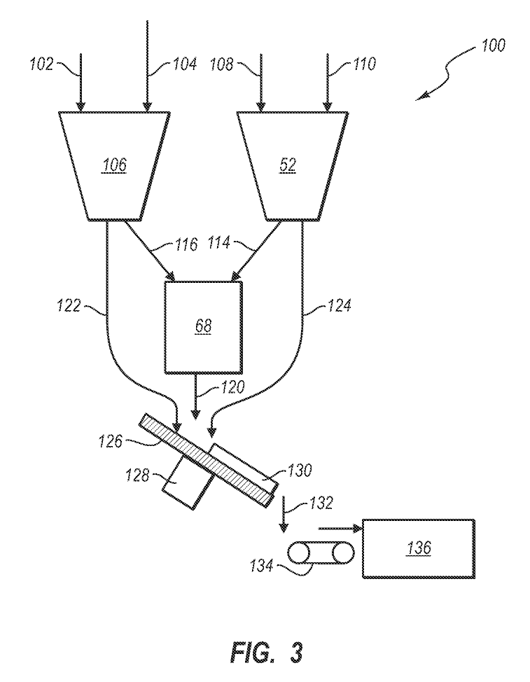

Referring now to FIG. 3, one embodiment of a pelleting system 100 is illustrated. As such, a fines feed line 102 is introduced into a vessel 106, where it can be mixed with an optional conditioner such as a solvent, rheology-modifier, additive, or other particulate filler material that is supplied by the optional feed line 104. The vessel 106 can include a heating element, mixing equipment, or other processing equipment for conditioning the fines. Otherwise, the fines can be supplied into the vessel 106 so that it can be precisely metered during the pelleting process.

Additionally, an asphalt binder feed line 108 is introduced into a binder vessel 112 with heating capabilities, where it is mixed with ground tire rubber or other rubber supplied by the optional feed line 110. Also, the binder vessel 112 can be configured to accurately meter the binder composition for preparing the pellets. Moreover, the binder vessel 112 can be substantially similar to the vessel 106. The binder vessel 112 can heat the asphalt and rubber as described herein for 45 minutes or longer to prepare the rubberized asphalt binder.

In one embodiment, when the fines composition is ready for further processing, it is supplied into an optional mixer 118 via line 114 and combined with rubberized asphalt binder provided by line 116. The mixer 118 can then mix the fines and the binder together into a substantially homogeneous or uniform mixture.

A supply of a fines-binder composition can then be provided from the mixer 118 to a disc pelletizer 126 via line 120. The disc pelletizer 126 spins so as to cause the fines-binder composition to roll and ball into pellets, which are then removed from the disc pelletizer 126 via the hood 130 as a pellet flow 132.

Alternatively, a supply of fines can be provided by the vessel 106 directly to the disc pelletizer 126 via line 122. The fines composition resides on the disc pelletizer 126, which is rotated by a drive system 128, until a supply of rubberized asphalt binder is provided from the binder vessel 112 via line 124. The binder (e.g., asphalt binder, asphalt/rubber binder, asphalt/rubber/sasol binder etc.) is applied (e.g. drop-wise, sprayed, streamed, nebulized, or the like) by a slow flowing line, or spray onto the fines on the disc pelletizer 126. As the binder contacts the fines, a small pellet is formed. Thus, by providing a plurality of binder droplets, binder spray, or a binder stream to the fines, the pellets can individually form, or optionally combine, until large enough to be removed through the hood 130.

After the pellets are formed, a pellet flow 132 can supply the pellets onto a conveyor 134 that transports them to a coating system 136. The coating system 136 can apply the polymer, wax, or fines coating as described herein. Additional processing can then be performed with the asphalt pellets as described herein.

In an alternative embodiment, the fines and/or rubberized asphalt binder can be supplied directly to the disc pelletizer 126 without any processing, mixing, or conditioning. As such, the fines can be supplied via line 122 and the rubberized asphalt binder can be supplied by line 124, which then are combined on the disc pelletizer 126.

In one embodiment, the fines can be poured and the rubberized asphalt binder can be sprayed onto the fines, and the process can be repeated until a suitable pellet is formed. Optionally, the fines can be put into a rotating drum that drops the fines in a veil of falling material when they reach about 10:00 to about 11:00. When the fines are falling, the binder is sprayed into the fines by a spray to coat the fines and some stick together to form the pellets. The drum can be configured as a coater.

In one embodiment, the falling fines are sprayed in alternating fashion with rubberized asphalt binder and then water to fog and cool the fines. The process can include coating with rubberized asphalt binder, then fogging, and then spraying with a wax coating (or other coating), which can be done in series or in any variation. Alternatively, when the fine are sprayed with binder to form a suitable size, the wax coating (e.g., sasol wax) and water fogging can be alternated to form multiple coatings or a thicker coating. The process can be repeated a number of times; however, three times can be sufficient. Alternatively, a different coating other than a wax can be used, such as a hydrophobic polymer.

After the pellets are prepared, they are placed into a container for shipment or storage. The pellets are storage stable as described herein.

Additionally, the various steps and processes described herein can be rearranged, combined, eliminated, or otherwise modified in order to produce the lime pellets of the present invention. As such, the various equipment and/or processing steps illustrated in one figure can be combined with those of other figures as appropriate.

### V. Preparing Asphalt Paving Compositions

In one embodiment, the asphalt pellets can be used in preparing and/or modifying asphalt pavement. More particularly, the pellets can be used for preparing and/or modifying asphalt pavement by being added to at least one of the ingredients of hot mix asphalt during the manufacture thereof. The asphalt pellets can be the main source of asphalt or a source of enhancing a nominal amount of the local asphalt use for pavements and other infrastructure needs.

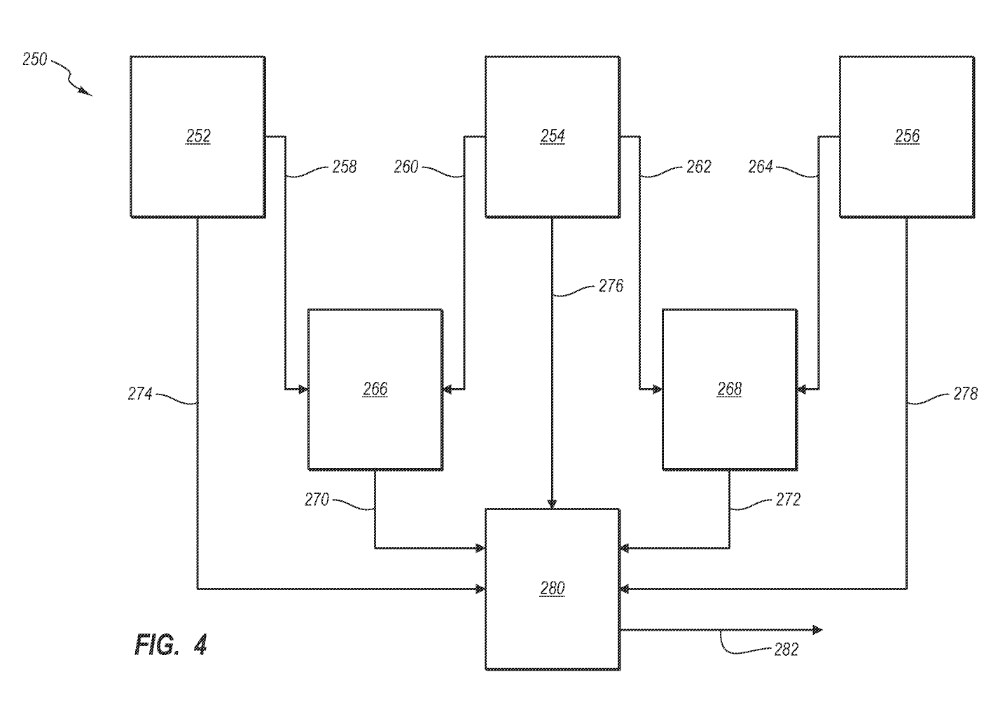

Accordingly, FIG. 4 includes a schematic diagram depicting an embodiment of a system and process 250 for manufacturing and/or conditioning asphalt pavement. Such a system and process 250 includes an aggregate supply 252, a pellet supply 254, and an asphalt cement supply 256. Additionally, the system and process 250 includes a means for combining pellets with at least one of the aggregates, such as sand, asphalt cement, or even with the asphalt itself. The asphalt pellets and asphalt can be combined with either being provided in a majority.

In one embodiment, the asphalt pellets can be the primary source of asphalt. As such, the pellets can be heated and blended into a hot mix asphalt (or medium temperature warm mix around 280 degrees F.) for use in asphalt paving. In certain circumstances, the pellets can be supplemented with regular asphalt, such as by adding 4-10% pellets to 1-2% regular asphalt oil to let down the composition and enhance blending.

In one embodiment, the aggregate supply 252 supplies aggregate material to a mixing vessel 266 via line 258. Additionally, the pellet supply 254 supplies rubberized asphalt pellets to the mixing vessel 266 via line 260. As such, the aggregate and pellets are mixed together in the mixing vessel 266. The pellets and aggregate can each be accurately measured so that a predetermined amount of aggregate and pellets can be supplied into the hot mix asphalt. For example, the pellets having lime can be metered and combined with a known amount of aggregate so that the lime is present from about 0.05% to about 10% by weight of aggregate, more preferably from about 0.1% to about 5% by weight, and most preferably about 0.5% to about 2.5% by weight of aggregate. The rubberized asphalt pellets having lime can be configured to provide the proper amount of asphalt for such amounts of aggregate and lime.

In one embodiment, the asphalt supply 256 supplies the asphalt such as bitumen to a second mixing vessel 268 (e.g., vortex mixer) via line 264. Optionally, the asphalt supply 256 is contained within a vessel, which may be equipped with heating elements (not shown) in order to heat the asphalt into a liquefied state in preparation for being combined with the pellets. Additionally, the pellet supply 254 supplies pellets to the second mixing vessel 268 via line 262. As such, the asphalt liquid and asphalt pellets are mixed together in the second mixing vessel 268, which can be equipped with heating elements (not shown) so that the asphalt cement is heated to a temperature sufficient for dissolving the pellets. This includes increasing the temperature of the asphalt past its melting point and past the melting or dissolving point of the pellet. For example, the second mixing vessel 268 can be heated to a dissolving temperature of greater than about 125° C. (257 F) and less than 165° C. (325 F), or around 280 degrees F.

In one embodiment, the second mixing vessel 268 (e.g., vortex mixer) can be configured for rapidly increasing the temperature of the pellets. As such, the pellets can be rapidly dissolved upon being introduced into the second mixing vessel 268 and upon contacting or being entrained within a liquefied asphalt cement composition. For example, a second mixing vessel 268 can rapidly heat the pellets so that they are substantially dissolved within a timeframe of less than about 1 minute, more preferably less than about 30 seconds, even more preferably less than about 20 seconds, and most preferably less than about 10 seconds. Additionally, in certain embodiments it can be preferred that the pellets dissolve within about 5 seconds to about 15 seconds.

The amount of asphalt cement and asphalt pellets that are mixed can be predetermined so that the resulting hot mix asphalt contains the proper amount of asphalt and any other components. With regard to ground tire rubber (GTR), it is preferred that the GTR is present in an amount greater than 10% by weight of asphalt cement, more preferably between about 10% to about 30% by weight, and most preferably between about 12% to about 28% by weight of asphalt cement.

In one embodiment, the aggregate-pellet mixture can be supplied from the mixing vessel 266 to the mix vessel 280 (e.g., pugmill, drum mixer, etc.) via line 270. Additionally, asphalt cement can be transported to the mix vessel 280 directly from the asphalt cement supply 256 via line 278. As such, the pellets and aggregate can be added directly into liquefied asphalt cement and mixed so that the resulting hot mix asphalt 282 supplied from the mix vessel 280 has a substantially homogeneous or uniform composition. The asphalt pellets can be heated and liquefied before, during, or after being combined with the aggregate and/or liquid.

In order to enhance mixing, the mix vessel 280 (e.g., pugmill, drum mixer, etc.), or any of the other vessels, can be equipped with a heating element so that the temperature is sufficiently high for maintaining a liquid continuous phase comprised of asphalt. Also, the temperature should rapidly dissolve the pellets so that the components in the pellet can be evenly distributed throughout the hot mix asphalt, wherein the temperature can be substantially the same as described-above with respect to the second mixer 268 (e.g., vortex mixer) so as to achieve dissolution of the pellets within the foregoing timeframes.

In one embodiment, the aggregate can be supplied from the aggregate supply 252 directly into the mix vessel 280 (e.g., pugmill, drum mixer, etc.) via line 274. Additionally, the asphalt mixture prepared in the second mixer 268 (e.g., vortex mixer) can be transported directly into the mix vessel 280 via line 272. Usually, the liquefied asphalt mixture is added to the mix vessel 280 prior to the addition of aggregate. In any event, the aggregate is mixed into the liquid asphalt mixture under heat so as to form hot mix asphalt 282 with a substantially homogeneous or uniform composition.

In one embodiment, the asphalt cement supply 256 supplies liquefied asphalt cement directly into the mix vessel 280 via line 278. The mix vessel 280 heats the asphalt cement so as to maintain or obtain liquid asphalt having the foregoing temperatures for providing the same pellet dissolution rates. Additionally, the pellet supply 254 supplies the pellets directly into the liquid asphalt within the mix vessel 280 via line 276. After the pellets have dissolved into the liquefied asphalt, or heated into liquefied asphalt, aggregate from the aggregate supply 252 can be added directly into the mix vessel 280 via line 274 and mixed with the liquid asphalt composition. After adequate mixing, a hot mix asphalt 282 is ready for use or further processing.

In view of the foregoing system and process 250 for manufacturing and conditioning asphalt, various other modifications and additions can be made under the current inventive concept. As such, additional supplies of sand, fly ash, adhesive additives, other fillers, and any other additive useful for preparing hot mix asphalt can be used and added to the system and process 250. Thus, many variations can be made to the process for using lime pellets for manufacturing and conditioning asphalt pavement.

Additionally, the system 250 can be modulated so that the rubberized asphalt pellets are heated and are the sole provider of asphalt, lime, and/or rubber. Additionally, the system 250 can be modulated so that the rubberized asphalt pellets are the main source of asphalt, and the pellets are let down with a small amount of liquefied asphalt.

Additionally, FIG. 4 can include the supply 254 being a lime and/or fines supply, and the asphalt supply 256 can include the rubberized asphalt pellets. As such, an additional feed of liquid asphalt (e.g., not pellets) can be introduced to the rubberized asphalt pellets as described herein.

The asphalt pellets used in preparing hot mix asphalt or other asphalt composition for paving can be supplied with 26% ground tire rubber with the balance of the binder being asphalt. These pellets can be heated in order to provide liquefied asphalt. The pellets can be combined with about 2% to 3% regular asphalt or bitumen in order to prepare the asphalt composition. The asphalt pavement composition can then be configured and prepared to include 15% ground tire rubber, such as is mandated by Arizona specifications for rubberized asphalt. If the pellets include about 20% ground tire rubber, the asphalt composition can be prepared without any additional liquefied asphalt or bitumen.

In one embodiment, the asphalt composition can be prepared to have 70 parts asphalt, 26 parts rubber, and 30 parts lime.

In one embodiment, preparing an rubberized asphalt composition, which can be used as a binder, includes combining rubber, such as ground tire rubber or crumb rubber, with asphalt. The mixture can be heated from about 350 degree F. to about 380 degrees F., which is customary for hot mix asphalt. However, the temperature for liquefying the pellets with or without the aggregate can be at a range from about 250 to 300 degrees F., or about 280 degrees F. The heated mixture is cooked for about 45 minutes to about an hour, however, it could be cooked for a longer time, such as 2 to 4 hours which is the maximum storage time at elevated temperatures.

The total asphalt paving composition can be prepared to have the appropriate amounts or concentrations of components. This can include about 5% asphalt and about 95% aggregate.

In one embodiment, the asphalt pellets are prepared into a rubberized asphalt pavement composition by being mixed with aggregate. The rubberized asphalt pellets are mixed at 7% with 93% aggregate. The asphalt paving composition with aggregate can then be applied as asphalt pavement as routinely practiced.

### VI. Binding Asphalt Layers

In one embodiment, the rubberized asphalt pellets can be used for enhancing the adhesion between two layers of asphalt pavement. As such, the paving pellets can be applied over the surface of a first layer of asphalt pavement, and then the compacted paving pellets are coated with a second layer of asphalt.

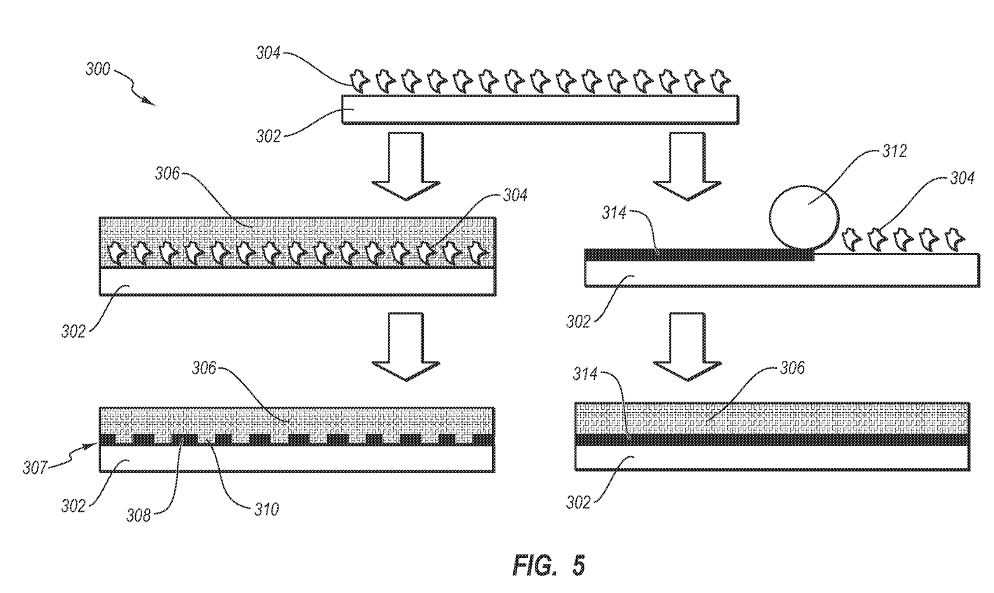

With reference now to FIG. 5, a schematic diagram illustrates embodiments of a bonding process 300 for binding different layers of asphalt pavement together. The bonding process 300 can be performed over an old or new layer of asphalt pavement 302. The asphalt pavement layer 302 can be an old layer of asphalt pavement that needs a topcoat or surfacing, or a new layer that has been recently deposited. In any event, the rubberized pellets 304 are applied over the asphalt pavement layer 302.

The rubberized asphalt paving pellets 304 can be applied to the asphalt pavement layer 302 by a variety of processes. Some of the exemplary processes include dumping the pellets into piles and raking or otherwise distributing the individual pellets substantially evenly across the top of the asphalt pavement layer 302. Alternatively, the paving pellets 304 can be substantially evenly sprinkled over the asphalt pavement layer 302. The amount of paving pellets 304 over a given area can be varied from a sparse coating where the pellets are spread apart without being in contact with each other through a dense coating where substantially all of the pellets are in contact with each other.

In one embodiment, after the rubberized asphalt paving pellets 304 have been applied to the first asphalt pavement layer 302, a layer of liquid asphalt cement 306 can be sprayed or otherwise deposited over the pellets 304 and first asphalt layer 302. As such, the liquid asphalt cement 306 can coat the rubberized asphalt pellets 304 and fill any spaces therebetween. Also, the thickness of the liquid asphalt layer 306 can be thick enough to cover the pellets 304 and first asphalt layer 302. The liquid asphalt cement 306 can also be an rubberized asphalt composition that includes aggregate.

Accordingly, the liquid asphalt can at least partially melt the rubberized asphalt pellets 304 and form a bonding layer 307. The bonding layer 307 can be comprised of pellet portions 308 and asphalt cement portions 310. As such, the pellet portions 308 can impart the rubberized asphalt composition into the asphalt portions 310 so as to enhance the bonding between the first asphalt layer 302 and the second asphalt layer 306. Also, since the second asphalt layer 306 is usually applied in a heated form, the components of the rubberized asphalt fines can also be distributed and suspended into the second asphalt layer 306. Thus, the rubberized asphalt pellets 304 can be used in facilitating and enhancing the bonding between different layers of asphalt.

In another embodiment, after the paving pellets 304 have been applied to the first asphalt pavement layer 302, a heavy roller 312 can be used to smash or compact the rubberized asphalt pellets 304 into a rubber asphalt layer 314. Alternatively, heat with or without any rolling or compacting devices 312 can be used to flatten the pellets 304 and/or form the bonding layer 314. As such, after a bonding layer 314 is formed, the second asphalt pavement layer 306 can be deposited thereon. Thus, the paving pellets layer 314 can be used to enhance the bonding between the first asphalt layer 302 and the second asphalt layer 306. While embodiments of processes for adhering asphalt layers together with paving pellets have been depicted and described, it should be appreciated that other variations to such processes can be made within the scope of the invention.

### VII. Asphalt Pavement

In one embodiment, the asphalt pellets can be used for laying asphalt pavement. As such, the pellets can be applied over a surface and heated so as to form asphalt pavement.

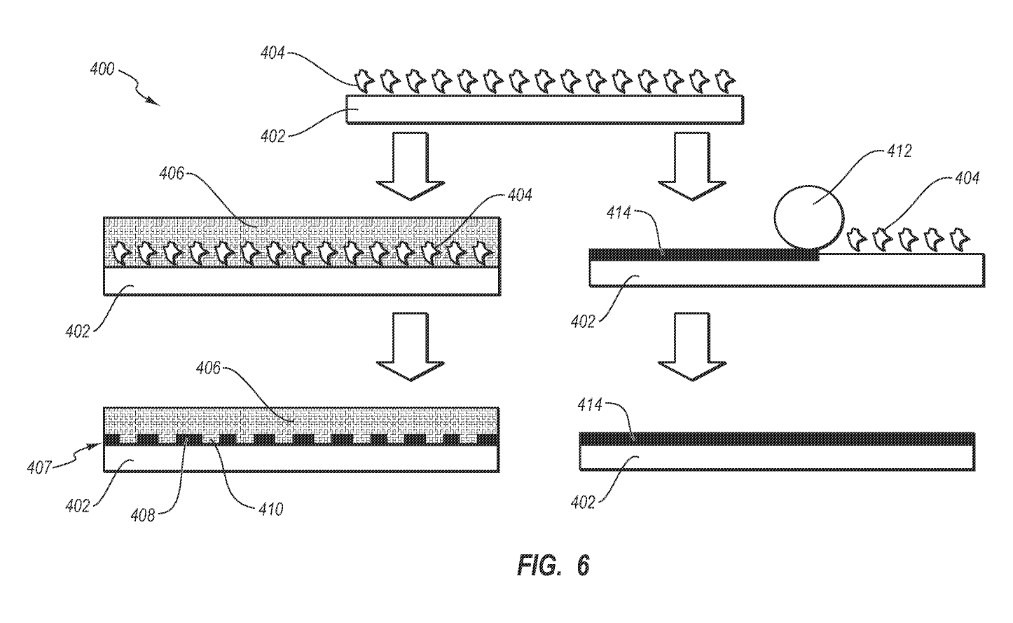

With reference now to FIG. 6, a schematic diagram illustrates embodiments of a paving process 400 for laying asphalt pavement. The paving process 400 can be performed over an old or new layer of asphalt pavement 402 or a bed layer of aggregate to form a new asphalt pavement. The asphalt pavement layer 402 can be an old layer of asphalt pavement that needs a topcoat or surfacing, or a new layer that has been recently deposited, or even a bed layer without any asphalt. In any event, the rubberized asphalt pellets 404 are applied over the layer 402.

The pellets 404 can be applied to the layer 402 by a variety of processes. Some of the exemplary processes include dumping the pellets into piles and raking or otherwise distributing the individual pellets substantially evenly across the top of the layer 402. Alternatively, the pellets 404 can be substantially evenly sprinkled over the layer 402. The amount of pellets 404 over a given area can be varied from a sparse coating where the pellets are spread apart without being in contact with each other through a dense coating where substantially all of the pellets are in contact with each other. When preparing a new layer, it is preferred that the pellets are piled so as to form an asphalt layer of sufficient thickness.

In one embodiment, after the pellets 404 have been applied to the first layer 402, a layer of liquid asphalt cement 406 (or asphalt paving composition with or without aggregate) can be sprayed or otherwise deposited over the pellets 404 and first layer 402. As such, the liquid asphalt cement 406 can coat the pellets 404 and fill any spaces therebetween. Also, the thickness of the liquid asphalt layer 406 can be thick enough to cover the pellets 404 and first asphalt layer 402.

Accordingly, the liquid asphalt can at least partially or fully melt the pellets 404 and form an asphalt layer 407. The asphalt layer 407 can be comprised of pellet portions 408 and asphalt cement portions 410, both of which can be combined so as to be substantially indistinguishable. As such, the pellet portions 408 can impart the fines and other components into the asphalt cement portions 410 so as to enhance the bonding between the first layer 402 and the second layer 406. Also, since the second layer 406 is usually applied in a heated and liquid form, the fines can also be distributed and suspended into the second layer 406. Thus, the pellets 404 can be used in facilitating and enhancing the bonding between different layers of asphalt or preparing good asphalt pavement.

In another embodiment, after the rubberized pellets 404 have been applied to the first pavement layer 402, a heavy roller 412 can be used to smash or compact the pellets 404 into an asphalt layer 414. Aggregate (not shown) can also be applied with the rubberized asphalt pellets before being rolled. Alternatively, heat with or without any rolling or compacting devices 412 can be used to flatten the pellets 404 and/or form the asphalt layer 414. While embodiments of processes for adhering asphalt layers together or prepare new asphalt pavement with asphalt pellets have been depicted and described, it should be appreciated that other variations to such processes can be made within the scope of the invention.

### EXAMPLES

### Example 1

An asphalt pellet core is prepared using a disc pelletizer and associated method. Briefly, a supply of fines is added to a rotating disc of a disc pelletizer in an amount that enables pellet formation. Liquefied pavement grade asphalt is then added drop-wise or sprayed onto the fines. Pellets are formed by asphalt droplets repeatedly contacting the fines, which can spill over edge of the pelletizer when reaching an adequate size. The average size of the pellets is expected to be 0.62 cm.

Alternatively, the fines are pored into a falling veil of fines and the binder is spraying into the fines to create the pellets. Optionally, alternating fogging and wax coating can provide shell and core asphalt pellets.

### Example 2

A series of pellet cores having varying compositions are prepared in accordance with the protocol of Example 1 with minor modifications. Briefly, varying compositions of liquefied rubberized asphalt-based binder are added to the fines. The feed rates of fines and/or binder are modified in order to alter pellet sizes and compositions. The expected shape, size (average diameter), and compositions of the pellet cores are described in Table 1 as follows:

TABLE 1

| Component | % (by weight) |
|---|---|
| PELLET 1 | |
| Spheroid (0.6 cm) | |
| Fines | 10 |
| Asphalt | 81 |
| Ground Tire Rubber | 9 |
| PELLET 2 | |
| Spheroid (0.35 cm) | |
| Fines | 5 |
| Asphalt | 91 |
| Calcium Chloride | 1 |
| Ground Tire Rubber | 3 |
| PELLET 3 | |
| Spheroid (0.5 cm) | |
| Calcium hydroxide Fines | 31 |
| Asphalt | 50 |
| Calcium chloride | 1.5 |
| Sodium chloride | 0.5 |
| Polymethylmethacrylate | 17 |
| PELLET 4 | |
| Spheroid (0.8 cm) | |
| Calcium hydroxide Fines | 20 |
| Asphalt | 75 |
| Calcium chloride | 1 |
| Ground Tire Rubber | 3 |
| Polyethylmethacrylate | 1 |
| PELLET 5 | |
| Spheroid (1.15 cm) | |
| Mineral Fines | 11 |
| Asphalt | 80 |
| Ground Tire Rubber | 9 |
| PELLET 6 | |
| Spheroid (0.2 cm) | |
| Rock Dust | 16 |
| Zero Pen AC | 79 |
| Ground Tire Rubber | 4 |
| Carbon black | 1 |
| PELLET 7 | |
| Spheroid (0.95 cm) | |
| Mineral Fines | 5 |
| AC-40 | 20 |
| Tall Oil Pitch | 55 |
| Ground Tire Rubber | 15 |
| Styrene-butadiene-styrene | 5 |
| PELLET 8 | |
| Spheroid (1.14 cm) | |
| Rock Dust | 25 |
| Ground Tire Rubber | 20 |
| PG-76-22 | 43 |
| Aliphatic petroleum distillate | 2 |
| Manganese oxide | 5 |
| Calcium chloride | 2 |
| Methyltrimethoxysilane | 1 |
| Fly ash | 2 |
| PELLET 9 | |
| Spheroid (2 cm) | |
| Fines | 20 |
| Rubberized Asphalt | 80 |
| PELLET 10 | |
| Spheroid (0.4 cm) | |
| Rock Dust | 40 |
| Asphalt | 40 |
| Ground Tire Rubber | 20 |
| PELLET 11 | |
| Spheroid (0.5 cm) | |
| Fines | 45 |
| Asphalt | 45 |
| Ground Tire Rubber | 10 |
| PELLET 12 | |
| Spheroid (0.3 cm) | |
| Mineral Fines | 42 |
| Asphalt | 42 |
| Ground Tire Rubber | 16 |

### Example 3

A series of rubberized asphalt pellet cores having varying compositions are prepared in accordance with the protocol of Example 1 with minor modifications. Briefly, varying compositions of liquefied binder are added drop-wise or sprayed onto the fines. The feed rates of lime and/or binder are modified in order to alter pellet core sizes and compositions. The expected shape, size (average diameter), and compositions of the pellets are described in Table 2 as follows:

TABLE 2

| Component | % (by weight) |
|---|---|
| PELLET 13 | |
| Spheroid (1.2 cm) | |
| Asphalt | 80 |
| Fines | 5 |
| Ground Tire Rubber | 15 |
| PELLET 14 | |
| Spheroid (0.35 cm) | |
| Rock Fines | 30 |
| Calcium oxide | 30 |
| Asphalt | 35 |
| Ground Tire Rubber | 4 |
| Carbon black | 1 |
| PELLET 15 | |
| Spheroid (0.25 cm) | |
| Ground Tire Rubber/Asphalt | 95 |
| Fines | 5 |
| PELLET 16 | |
| Spheroid (0.45 cm) | |
| Asphalt | 61 |
| Ground Tire Rubber | 21 |
| Fines | 7 |
| Manganese oxide | 4 |
| Fly ash | 5 |
| Carbon black | 2 |
| PELLET 17 | |
| Spheroid (0.2 cm) | |
| Asphalt | 91 |
| Ground Tire Rubber | 9 |
| Fly ash Fines | 5 |
| Calcium chloride | 3 |
| Carbon black | 2 |
| PELLET 18 | |
| Spheroid (2.3 cm) | |
| Asphalt | 98 |
| Ground Tire Rubber | 1 |
| Fines | 1 |
| PELLET 19 | |
| Spheroid (1.5 cm) | |
| Asphalt | 70 |
| Ground Tire Rubber | 10 |
| Fines | 20 |
| PELLET 20 | |
| Spheroid (1.2 cm) | |
| Asphalt | 80 |
| Fines | 5 |
| Ground Tire Rubber | 15 |
| PELLET 21 | |
| Spheroid (1.7 cm) | |
| Asphalt | 85 |
| Ground Tire Rubber | 2.5 |
| Fines | 12.5 |
| PELLET 22 | |
| Spheroid (2.4 cm) | |
| Asphalt/GTR | 90 |
| Rock Fines | 0.5 |
| Lime Fines | 9.5 |
| PELLET 23 | |
| Spheroid (0.3 cm) | |
| Asphalt/GTR | 61 |
| Calcium oxide | 20 |
| Rock Fines | 16 |
| Sand | 3 |

### Example 4

A pellet is prepared as described in Example 1. Briefly, a supply of fines combined with manganese oxide is added to the rotating disc of a disc pelletizer, and Asphalt/GTR is added drop-wise. Pellets are formed by contacting the binder with the fines. The average size of the pellets is expected to be 0.95 cm with a composition of 90% asphalt GTR, 0.5% manganese oxide, and 9.5% Fines.

### Example 5

A pellet is prepared using a disc pelletizer and associated method as described in Example 1. Briefly, a supply of fines combined with manganese oxide is added to the rotating disc of a disc pelletizer, and liquefied bitumen is added drop-wise. Pellets are formed by contacting the bitumen with the fines. The average size of the pellets is expected to be 1.27 cm with a composition of 97% bitumen, 1% manganese oxide, and 2% fines.

### Example 6

A series of pellet cores having varying compositions are prepared in accordance with the protocol of Example 1 with minor modifications. Briefly, varying compositions of asphalt are combined with lime fines (calcium hydroxide and/or calcium oxide). The expected shape, size (average diameter), and compositions of the pellet cores are described in Table 3 as follows:

TABLE 3

| Component | % (by weight) |
|---|---|
| PELLET 24 | |
| Spheroid (2 cm) | |
| Calcium hydroxide | 8 |
| Asphalt | 91 |
| Manganese oxide | 1 |
| PELLET 25 | |
| Spheroid (1.3 cm) | |
| Calcium hydroxide | 10 |
| Asphalt | 85 |
| Styrene-butadiene-styrene | 3 |
| Manganese oxide | 2 |
| PELLET 26 | |
| Spheroid (1.5 cm) | |
| Calcium hydroxide | 20 |
| Asphalt | 70 |
| Styrene-butadiene rubber | 5 |
| Phosphorus oxide | 2 |
| Manganese oxide | 3 |
| PELLET 27 | |
| Spheroid (0.8 cm) | |
| Calcium hydroxide | 30 |
| Asphalt | 55 |
| Fly ash | 8 |
| Potassium chloride | 5 |
| Manganese oxide | 2 |
| PELLET 28 | |
| Spheroid (0.5 cm) | |
| Calcium hydroxide | 20 |
| Asphalt | 60 |
| Styrene-butadiene-styrene | 3 |
| Silica | 5 |
| Sand | 2 |
| Sodium chloride | 5 |
| Manganese oxide | 5 |

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

This application cross-references U.S. Pat. No. 7,303,623, filed on May 20, 2005, entitled “PELLETING LIME FINES WITH ASPHALT ENHANCING BINDERS AND METHODS FO USE IN ASPHALT MANUFACTURING,” with William R. Bailey as the inventor, and U.S. patent application having Ser. No. 11/932,713, filed on Oct. 31, 2007, entitled “A PROCESS FOR PREPARING LIME PELLETS,” with William R. Bailey as the inventor, which applications are incorporated herein in their entirety by specific reference.

1. A storage-stable asphalt paving pellet, comprising:
a core comprising:
ground tire rubber from about 15% to about 30% by weight of the core; and
pavement grade asphalt from about 85% to about 70% by weight of the core; and
a shell coating the core such that the pellet has a maximum dimension of about 1/16 inch to about 2 inches, the shell comprising:
a water-resistant polymer or wax; or
fines.

2. A pellet as in claim 1, characterized by one or more of the following:
the ground tire rubber at about 15% to about 25% by weight of the total pellet;
the pavement grade asphalt at about 50% to about 60% by weight of the total pellet;
the core having less than about 10% by weight being sulfur;
the fines are lime fines at less than about 40% by weight of the total pellet; or
the coating is wax.

3. A storage-stable asphalt paving pellet, comprising:
a core comprising:
an asphalt-based binder at about 70% to about 95% by weight of the core, the asphalt-based binder comprising:
ground tire rubber from about 15% to about 30% by weight of the asphalt-based binder; and
pavement grade asphalt from about 85% to about 70% by weight of the asphalt based binder; and
fines at about 1% to about 45% by weight of the core; and
a shell coating the core such that the pellet has a maximum dimension of about 1/16 inch to about 2 inches, the shell comprising:
a water-resistant polymer or wax; or
fines.

4. A pellet as in claim 3, wherein the fines are lime fines or ground asphalt pavement fines.

5. A pellet as in claim 3, characterized by one or more of the following:
the ground tire rubber at about 15% to about 25% by weight of the total pellet;
the pavement grade asphalt at about 50% to about 60% by weight of the total pellet;
the core having less than about 10% by weight being sulfur;
the fines are lime fines between about 35% to about 45% by weight of the total pellet; or
the coating is wax.

6. A pellet as in claim 3, characterized by one or more of the following:
the ground tire rubber from about 20% to about 26% by weight of the asphalt-based binder;
the pavement grade asphalt from about 74% to about 80% by weight of the asphalt based binder; or
the fines are lime fines at less than about 40% by weight of the total pellet.

7. A pellet as in claim 6, further comprising one or more of the following:
rock and/or mineral fines;
an additional bituminous binder;
a non-bituminous binder;
a structural additive;
a colorant;
a salt; or
a rheology-modifier.

8. A pellet as in claim 7, wherein the non-bituminous binder is selected from the group of hydrophobic binders, cellulosic binders, hydrophilic binders, organic binders, natural polymer binders, lignin and/or lignosulfonate or acid thereof, polysaccharide or modified polysaccharide binder, or combinations thereof.

9. A method of manufacturing the pellet of claim 3, the method comprising:
obtaining the ground tire rubber;
obtaining the pavement grade asphalt;
reacting the ground tire rubber and pavement grade asphalt for at least 45 minutes to form a reaction mixture;
combining the reaction mixture with fines to form the core; and
coating the core with a shell to form the pellet.

10. A method as in claim 9, wherein the reacting is conducted at about 350 to about 380 degrees F.

11. A method as in claim 10, characterized by one or more of the following:
reacting the ground tire rubber at about 15% to about 25% by weight of the total pellet with the pavement grade asphalt at about 50% to about 60% by weight of the total pellet;
reacting the ground tire rubber from about 20% to about 26% by weight of the asphalt-based binder with the pavement grade asphalt from about 74% to about 80% by weight of the asphalt based binder;
inhibiting the core from having more than about 10% by weight being sulfur;
inhibiting the amount of fines to be more than about 45% by weight of the total pellet;
spraying the water-resistant coating onto the pellet; or
applying the fines as a coating onto the pellet.

12. A method as in claim 11, further comprising one or more of the following:
combining rock and/or mineral fines with the reaction mixture with fines to form the core;
combining an additional bituminous binder with the reaction mixture with fines to form the core;
combining a non-bituminous binder with the reaction mixture with fines to form the core;
combining a structural additive the reaction mixture with fines to form the core;
combining a colorant with the pellet;
combining a salt with the reaction mixture with fines to form the core; or
combining a rheology-modifier with the reaction mixture with fines to form the core.

13. A method pellet as in claim 12, wherein the non-bituminous binder is selected from the group of hydrophobic binders, cellulosic binders, hydrophilic binders, organic binders, natural polymer binders, lignin and/or lignosulfonate or acid thereof, polysaccharide or modified polysaccharide binder, or combinations thereof.

14. A method as in claim 10, wherein the fines consist essentially of calcium hydroxide.

15. A method as in claim 10, wherein the fines consist essentially of calcium oxide.

16. A method of preparing a paving asphalt composition, the method comprising:
providing the asphalt pellet of claim 1;
heating the asphalt pellets into a liquefied asphalt composition; and
combining the liquefied asphalt composition with aggregate.

17. A method as in claim 16, wherein the aggregate is at least 90% by weight of the hot mix asphalt.

18. A method as in claim 17, further comprising adding additional pavement grade asphalt to the liquefied asphalt composition, wherein the additional pavement grade asphalt is an amount from about 1% to about 5% of the amount of the asphalt pellet.

19. A method of preparing hot mix asphalt, the method comprising:
providing the asphalt pellet of claim 3;
heating the asphalt pellets into a liquefied asphalt composition; and
combining the liquefied asphalt composition with aggregate.

20. A method as in claim 19, wherein the aggregate is at least 90% by weight of the hot mix asphalt.

21. A method as in claim 20, further comprising adding additional pavement grade asphalt to the liquefied asphalt composition, wherein the additional pavement grade asphalt is an amount from about 1% to about 5% of the amount of the asphalt pellet.

22. A method as in claim 20, wherein the heating is performed at a temperature lower than 325 degrees F.

23. A method as in claim 22, wherein the heating is performed at a temperature range from about 270 degrees F. to about 290 degrees F.

24. A method as in claim 23, wherein the heating is at about 280 degrees F.

25. An asphalt pellet product, comprising:
a bag; and
about 25 to about 100 pounds of the asphalt pellet of claim 1 in the bag.

26. An asphalt pellet product, comprising:
a bag; and
about 25 to about 100 pounds of the asphalt pellet of claim 3 in the bag.
